(19) United States
(12) Patent Application Publication
(10) Pub. No.: US 2026/0135630 A1
(43) Pub. Date: May 14, 2026

(54) RS CONFIGURATION AND WIRELESS INTERFERENCE MITIGATION

(71) Applicant: Charter Communications Operating, LLC, St. Louis, MO (US)

(72) Inventors: Marcus Maranhao, Irvine, CA (US); Muhammad Usman Fazili, Audubon, PA (US); Phillip B. Oni, Watertown, NY (US); Dumitru M. lonescu, Poway, CA (US)

(21) Appl. No.: 19/381,363

(22) Filed: Nov. 6, 2025

Related U.S. Application Data
(60) Provisional application No. 63/718,341, filed on Nov. 8, 2024.

(51) Int. Cl. H04B 17/345; H04W 24/08

(52) U.S. Cl. CPC H04B 17/345; H04W 24/08

(57) ABSTRACT

A wireless communication system includes at least a first wireless station and a second wireless station. The first wireless station receives reference signal configuration information indicating a configuration of a second wireless station transmitting reference signals. The first wireless station monitors for receipt of the reference signals as indicated by the reference signal configuration information. Based on receipt of a first reference signal as indicated by the reference signal configuration information, the first wireless station detects wireless interference at the first wireless station as caused by the second wireless station transmitting a respective wireless beam including the first reference signal. The respective wireless beam may be transmitted by the second wireless station to convey data to a mobile communication device.

### RELATED APPLICATION

This application claims the benefit of earlier filed U.S. Provisional Patent Application Ser. No. 63/718,341 entitled “CLI measurement resource configuration, CLI mitigation, and CLI testing,” (Attorney Docket No. CHTR-2024-198P), filed on Nov. 8, 2024, the entire teachings of which are incorporated herein by this reference.

### BACKGROUND

In a proposed wireless standard, there is an evaluation of a new feature called Sub-Band Full Duplex (SBFD), which allows a legacy TDD (Time Division Duplex) slot or symbol, which is configured as “Downlink” or “Flexible,” to have so-called tones (Bandwidth) allocated for simultaneous “Downlink” and “Uplink” wireless transmissions. In other words, implementation of so-called SBFD enables both downlink and uplink wireless transmissions between 2 wireless stations in a given time slot of a time slotted communication configuration.

In general, so-called gNodeBs (a.k.a., wireless base stations) in a network environment may support half duplex communications via implementation of a TDD (Time Division Duplex) configuration and, alternatively, may support full duplex communications in a FDD (Frequency Division Duplex) configuration. In this latter case of implementing FDD, the gNodeBs can be configured to simultaneously receive and transmit wireless signals on the same carrier frequency.

In certain operating conditions, implementation of SBFD or wireless communications in general causes cross-link interference (CLI) such as adjacent channel CLI (interference from a different channel) or co-channel interference (interference from the same channel) to nearby neighboring wireless networks. As further discussed below, FIG. 1 and FIG. 2 illustrate implementation of a conventional SBFD communication configuration.

### BRIEF DESCRIPTION OF EXAMPLES

Techniques herein include enabling a so-called victim gNodeB (wireless base station) to request its neighbor aggressor gNodeB (wireless base station) for CLI (Cross Link Interference) mitigation. In one example, if the aggressor gNodeB requested a test of a victim gNodeB, and the victim gNodeB responded with the test results, then the aggressor wireless base station (gNodeB) can be configured to decide based on the test results to take some action to mitigate the CLI power interference it causes to the victim gNodeB.

Examples as discussed herein promote more efficient use of wireless resources by reducing wireless interference amongst multiple wireless stations communicating in a wireless network environment.

More specifically, a wireless communication system as discussed herein includes at least a first wireless station and a second wireless station. The first wireless station receives reference signal configuration information indicating a configuration of a second wireless station transmitting reference signals in different wireless beams from the second wireless station. The first wireless station monitors for receipt of the reference signals as indicated by the reference signal configuration information. Based on receipt of a first reference signal (is transmitted from the second wireless station) as indicated by the reference signal configuration information, the first wireless station detects wireless interference at the first wireless station as caused by the second wireless station transmitting a respective wireless beam supporting transmission of the first reference signal. In addition to transmitting the first reference signal, the respective wireless beam may be transmitted by the second wireless station to convey data to a mobile communication device in the network environment. The second wireless station use of a small portion of the bandwidth associated with the respective wireless beam to transmit the first reference signal advantageously supports interference detection by other wireless stations.

In response to detecting the wireless interference at the first wireless station, the first wireless station can be configured to notify the second wireless station regarding the detected wireless interference. The notification from the first wireless station to the second wireless station may include any suitable information such as an identity of the respective wireless beam (including the transmitted first reference signal) or identity of the wireless base station causing the detected wireless interference or the identity of the transmitted first signal. In one example, the detected wireless interference may be mitigated based on the second wireless station modifying its usage of the respective wireless beam to communicate with the mobile communication device.

In accordance with further examples, the first wireless station transmits a notification notifying the second wireless station of the detected wireless interference at the first wireless station. In order to reduce the magnitude of the wireless interference to the first wireless station, the second wireless station can be configured perform any suitable operation. In one example, to reduce the magnitude of the wireless interference, the second wireless station adjusts a power level of the second wireless station transmitting the particular wireless beam (which included the transmission of the first reference signal), which is transmitted by the second wireless station to communicate data to a respective first mobile communication device. Other mitigation is possible such as termination of use of the particular wireless beam by the second wireless station.

In a similar manner, each of the wireless stations in the network environment can be configured to transmit reference signal configuration information indicating a respective configuration of that corresponding wireless station transmitting reference signals. Distribution of the reference signal configuration information and corresponding monitoring and transmission interference feedback amongst the wireless stations enables the wireless stations to reduce overall wireless interference in the network environment.

In accordance with another example, in response to detecting the wireless interference, the first wireless station can be configured to transmit a first communication from the first wireless station to the second wireless station, where the first communication requests mitigation of the detected wireless interference by the second wireless station.

The first communication may include a request for the second wireless station to adjust use of a respective wireless beam from which the first reference signal and potentially data signals are transmitted from the second wireless station.

Further, the reference signals as indicated by the reference signal configuration information may be uniquely encoded wireless reference signals transmitted in multiple different directional wireless beams from the second wireless station, where the first reference signal is wirelessly transmitted in a first wireless beam of the multiple different wireless beams.

In still further examples, the first communication transmitted from the first wireless station to the second wireless station can be configured to indicate that the transmission of the first wireless beam from the second wireless station results in the wireless interference to the first wireless station. The second wireless station is operative to transmit both the first reference signal and a first data signal via the first wireless beam, where the first data signal is transmitted from the second wireless station via the first wireless beam to a third wireless station such as a mobile communication device. As discussed herein, transmission of the first wireless beam corresponding first reference signal enable the second wireless station to check the interference.

Still further, based on attributes of the first reference signal, the first wireless station determines an identity of a first wireless beam from which the second wireless station transmits the first reference signal. In one example, the first wireless station is configured to, using the reference signal configuration information or other suitable information, map the identity of the received first reference signal to an identity of the first beam (transmitting the first reference signal) and a corresponding second wireless station transmitting the first reference signal. In response to detecting the wireless interference, the wireless station can be configured to transmit a first communication from the first wireless station to the second wireless station, where the first communication indicates the identity of the first wireless beam or the identity of the received reference signal which indicates the first wireless beam. The first communication as generated and transmitted by the first wireless station may include any suitable information indicating which wireless the cause the interference to the first wireless station.

As previously discussed, the first communication may include a request for the second wireless station to mitigate the wireless interference caused by the second wireless station transmitting the first wireless beam. In response to transmitting the first communication, the first wireless station receives a second communication from the second wireless station, where the second communication includes at least a notification of an attempt by the second wireless station to mitigate the wireless interference.

Yet further, the attempt by the second wireless station to mitigate the wireless interference to reduce the wireless interference caused by the second wireless station transmitting the first wireless beam (that is, being causing the wireless interference) may include the second wireless base station, in response to the first wireless station detecting a desired amount of reduction in the wireless interference caused by the second wireless station transmitting the first wireless beam, transmitting a third communication from the first wireless station to the second wireless station, where the third communication notifies the second wireless station to terminate further mitigation of the wireless interference caused by the second wireless station transmitting the first wireless beam. In other words, if the first wireless station eventually detects that the amount of wireless interference caused by the second wireless station transmitting the first wireless beam below a threshold level, the first wireless station can be configured to notify the second wireless station that there is no longer wireless interference to the first wireless station.

Still further, examples herein include the first wireless station transmitting a first communication to the second wireless station in response to detecting that the first reference signal is received at the first wireless station above a first wireless power threshold level. In one example, the first communication transmitted from the first wireless station to the second wireless station indicates that the transmission of the first reference signal from the second wireless station results in the wireless interference to the first wireless station.

In still further examples as discussed herein, the reference signal configuration information received at the first wireless station is second reference signal configuration information received from the second wireless station; the reference signals as indicated by the second reference signal configuration information are second reference signals. The first wireless station or other suitable entity can be configured to transmit first reference signal configuration information from the first wireless station to the second wireless station, where the first reference signal configuration information indicates a configuration of the first wireless station transmitting first reference signals in multiple different wireless beams. Subsequent to transmitting the first reference signal configuration information associated with the first wireless station to the second wireless station, the first wireless station may receive a communication from the second wireless station, where the communication indicates that transmission of a second wireless beam from the first wireless base station results in wireless interference to the second wireless station. In such an instance, the first wireless station performs interference mitigation by adjusting use of the second wireless beam.

Yet further, the first wireless station can be configured to monitor for receipt of the reference signals as indicated by the reference signal configuration information in response to receiving a command from the second wireless station, where the command indicates to implement wireless interference testing at the first wireless station for presence of the first reference signal.

In a further example as discussed herein, the reference signal configuration information as received by the first wireless station provides a mapping of the reference signals or attributes of the reference signals transmitted by the second wireless station to corresponding wireless beams used by the second wireless station to transmit the reference signals. Thus, via the reference signal configuration information, the first wireless station is able to identify which of the other wireless stations in the network environment transmitted the first reference signal and/or a specific wireless beam transmitted by the second wireless station causing the interference.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), non-transitory computer-readable storage media, etc., on which software instructions are encoded for subsequent execution.

The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage hardware medium or computer readable hardware such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example as discussed herein includes computer readable storage hardware and/or system having instructions stored thereon to facilitate better use of available wireless resources. The instructions, when executed by computer processor hardware, cause the computer processor hardware (such as one or more co-located or disparately processor devices or hardware) to: at a first wireless station: receive reference signal configuration information indicating a configuration of a second wireless station transmitting reference signals; monitor for receipt of the reference signals as indicated by the reference signal configuration information; and based on receipt of a first reference signal as indicated by the reference signal configuration information, contact wireless interference at the first wireless station as caused by the second wireless station.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of supporting efficient wireless communication services. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment and scheduling of so-called SBFD (Sub-Band Full Duplex) as discussed herein.

FIG. 2 is an example diagram illustrating simultaneous use of different portions of a frequency band to support simultaneous uplink and downlink wireless communications as discussed herein.

FIG. 3 is an example diagram illustrating distribution of reference signal configuration information and use of the distributed reference signal configuration information to determine one or more sources of cross-link interference as discussed herein.

FIG. 4 is an example diagram illustrating reference signal configuration information implemented by a second wireless station as discussed herein.

FIG. 5 is an example diagram illustrating distribution of reference signal configuration information and use of the distributed reference signal configuration information to determine one or more sources of cross-link interference as discussed herein.

FIG. 6 is an example diagram illustrating reference signal configuration information implemented by a first wireless station as discussed herein.

FIG. 7 is an example diagram illustrating demarcation of communication processing functions and corresponding network communication layers in a protocol stack as discussed herein.

FIG. 8 is an example diagram illustrating example computer architecture operable to execute one or more operations as discussed herein.

FIG. 9 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A wireless communication system as discussed herein includes at least a first wireless station and a second wireless station. The first wireless station receives reference signal configuration information indicating a configuration of a second wireless station transmitting reference signals in different wireless beams. The first wireless station monitors for receipt of the reference signals as indicated by the reference signal configuration information. Based on receipt of a first reference signal as indicated by the reference signal configuration information, the first wireless station detects wireless interference at the first wireless station as caused by the second wireless station transmitting a specific wireless beam supporting transmission of the first reference signal.

In response to detecting the wireless interference at the first wireless station, the first wireless station can be configured to notify the second wireless station regarding the detected wireless interference. The notification from the first wireless station to the second wireless station may include any suitable information such as an identity of the respective wireless beam (including the transmitted first reference signal) or wireless base station causing the detected wireless interference. In one example, the detected wireless interference may be mitigated based on the second wireless station modifying its usage of the respective wireless beam to communicate with the mobile communication device.

In accordance with further examples, the first wireless station transmits a message notifying the second wireless station of the detected wireless interference at the first wireless station. In order to reduce the magnitude of the wireless interference, the second wireless station can be configured to perform any suitable operation. In one example, to reduce the magnitude of the wireless interference, the second wireless station adjusts a power level of the second wireless station transmitting the particular wireless beam, which is transmitted by the second wireless station to communicate data to a respective first mobile communication device. Other mitigation is possible such as termination of use of the particular wireless beam by the second wireless station.

In a similar manner, each of the wireless stations or other suitable entity in the network environment can be configured to transmit reference signal configuration information indicating a respective configuration of a corresponding wireless station transmitting reference signals. Distribution of the reference signal configuration information and corresponding monitoring and transmission of interference feedback amongst the wireless stations enables the wireless stations to reduce overall wireless interference in the network environment.

These and more specific examples are further discussed below.

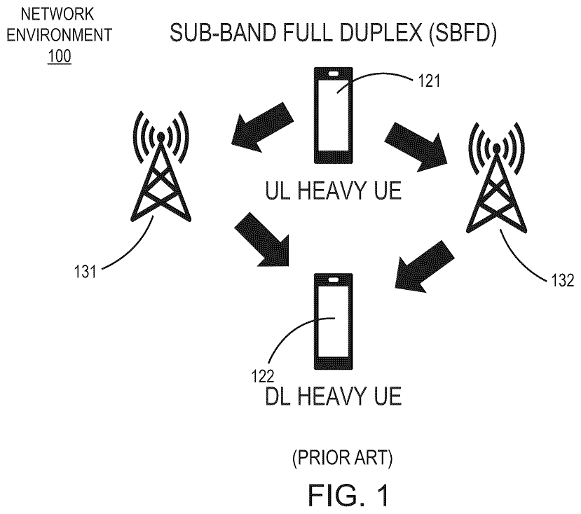

Now, more specifically, FIG. 1 is an example diagram illustrating a network environment and scheduling of so-called SBFD (a.k.a., Sub-Band Full Duplex) as discussed herein.

In this example, the network environment 100 includes wireless base station 131, wireless base station 132, . . . , mobile communication device 121 (a.k.a., user equipment), mobile communication device 122 (a.k.a., wireless station, user equipment, UE, etc.), etc.

Note that each of the wireless base stations in the network environment 100 is a wireless station supporting wireless communications with other wireless stations. Each wireless base station may be a gNodeB or other suitable entity supporting wireless communications in a network environment 100. As further discussed below, the wireless base stations such as gNBs communicate with each other over the network 190 or other suitable entity. The wireless signals that gNB1 (wireless base station 131) and gNB2 (wireless base station 132) transmit to reach their respective UE (the intended target 121 and 122), is somehow unintentionally leaking and being received/detected by the neighboring gNBs.

As further shown in FIG. 1, the network environment 100 can be configured to support so-called sub-band full duplex (SBFD) communications.

Further, via uplink wireless communications from the mobile communication device 121, the mobile communication device 121 is able to convey respective data in an uplink direction to either the wireless base station 131 and/or the wireless base station 132.

In a reverse direction, via downlink wireless communications from the wireless base station 131 and wireless base station 132, the mobile communication device 121 is able to receive respective data in a downlink direction from either the wireless base station 131 and/or the wireless base station 132.

Further, via uplink wireless communications from the mobile communication device 122, the mobile communication device 122 is able to convey respective data in an uplink direction to either the wireless base station 131 and/or the wireless base station 132. In a reverse direction, via downlink wireless communications from the wireless base station 131 and wireless base station 132, the mobile communication device 121 is able to receive respective data in a downlink direction from either the wireless base station 131 and/or the wireless base station 132.

As further discussed herein, simultaneous transmission of wireless communications from any of the wireless stations (wireless base station 131, wireless base station 132, . . . , mobile communication device 121, mobile communication device 122, . . . ) may result in undesirable wireless interference.

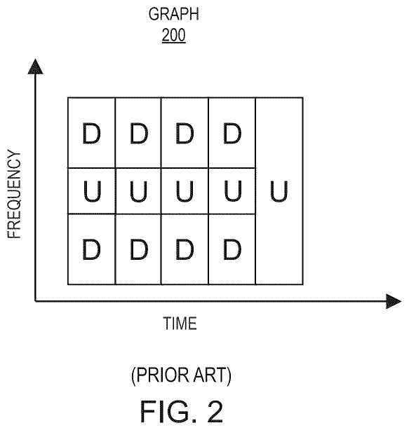

FIG. 2 is an example diagram illustrating simultaneous use of different portions of a frequency band to support both uplink and downlink communications as well as SBFD communications as discussed herein.

As shown in graph 200, implementation of sub-band frequency division communications includes support of simultaneous uplink and downlink communications in the same timeslot.

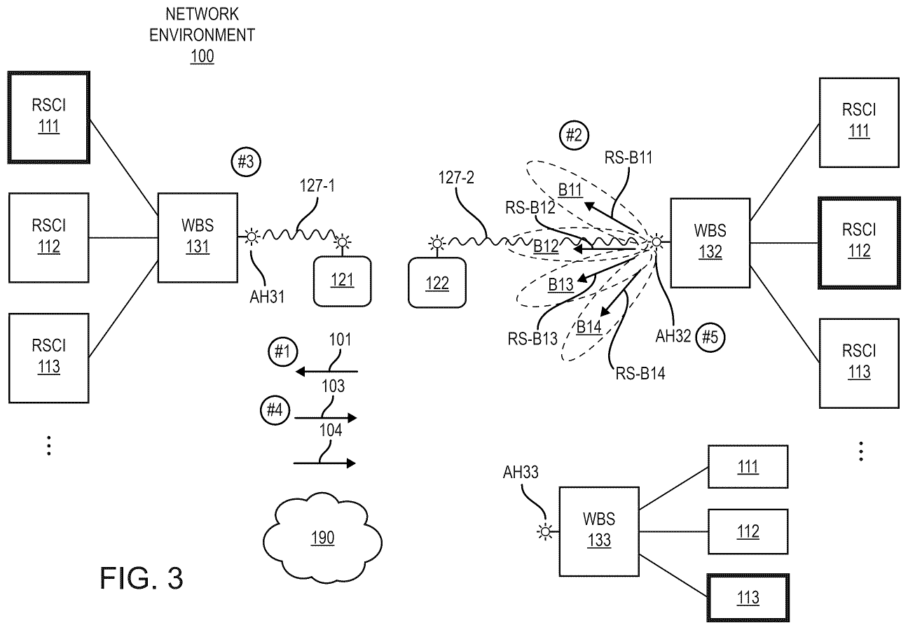

FIG. 3 is an example diagram illustrating distribution of reference signal configuration information and use of the distributed reference signal configuration information to mitigate cross-link interference amongst wireless stations as discussed herein.

As shown in FIG. 3, the network environment 100 includes multiple wireless base stations such as wireless base station 131, wireless base station 132, wireless base station 133, etc., mobile communication device 121, mobile communication device 122, etc. The network environment 100 further includes the network 190 providing wired or wireless connectivity between each of the wireless base stations.

Wireless base station 131 includes antenna hardware AH31 to transmit and receive wireless signals in the network environment 100; wireless base station 132 includes antenna hardware AH32 to transmit and receive wireless signals in the network environment 100; wireless base station 133 includes antenna hardware AH33 to transmit and receive wireless signals in the network environment 100; and so on.

Each of the wireless base stations in the network environment 100 is assigned corresponding reference signal configuration information indicating attributes of wireless reference signals transmitted in different beams from a corresponding wireless base station.

For example, the wireless base station 131 is assigned use of and configured with the reference signal configuration information 111, which indicates scheduling and attributes of one or more different wireless reference signals transmitted from different wireless beams from the antenna hardware AH31 of the wireless base station 131.

The wireless base station 132 is assigned use of and configured with the reference signal configuration information 112, which indicates scheduling and attributes of one or more different wireless reference signals transmitted from different wireless beams from the antenna hardware AH32 of the wireless base station 132.

The wireless base station 133 is assigned use of and configured with the reference signal configuration information 113, which indicates scheduling and attributes of one or more different wireless reference signals transmitted from different wireless beams from the antenna hardware AH33 of the wireless base station 133; and so on.

Accordingly, each instance of the reference signal configuration information assigned to a respective wireless base station provides notification of a schedule of the wireless base stations transmitting the respective reference signals.

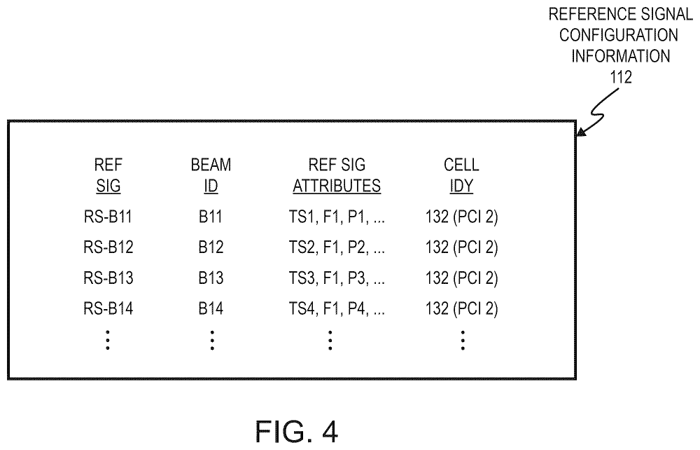

It is noted that the wireless base station 132, wireless base station 133, etc., are located in a vicinity of the wireless base station 131. Based on the nearness of the wireless base stations 132, 133, etc., to the wireless base station 131, there is the possibility of wireless interference caused by each of the wireless base stations to each other. As further discussed below, there is not a single reference signal assigned to a base station. Each cell and each beam ideally transmit different reference signals from different beams. Also, it is noted that a reference signal is more complex than thinking of it as a schedule of their transmission. As further discussed below in FIG. 4, each wireless base station transmits a different unique reference signal from each respective wireless beam.

Referring again to FIG. 3, in such an instance, to support wireless interference mitigation amongst the wireless base stations (i.e., wireless stations), the wireless base station 131 receives reference signal configuration information 112 indicating wireless reference signals transmitted in different wireless beams from the wireless base station 132; the wireless base station 131 receives reference signal configuration information 113 indicating wireless reference signals transmitted in different wireless beams from the wireless base station 133; and so on. As discussed herein, note that if base station 131 detects RS-B12, the wireless base station 131 will know that the interference is coming from base station 132 based on use of the reference signal configuration information 112.

In a similar manner, to support the wireless interference mitigation amongst the wireless base stations, the wireless base station 132 receives reference signal configuration information 111 indicating wireless reference signals transmitted in different wireless beams from the wireless base station 131; the wireless base station 132 receives reference signal configuration information 113 indicating wireless reference signals transmitted different wireless beams from the wireless base station 133; and so on.

Further, to support the wireless interference mitigation amongst the wireless base stations, the wireless base station 133 receives reference signal configuration information 111 indicating wireless reference signals transmitted in different wireless beams from the wireless base station 131; the wireless base station 133 receives reference signal configuration information 112 indicating wireless reference signals transmitted different wireless beams from the wireless base station 132; and so on.

As discussed herein, it is noted together any suitable type or form of network connectivity (wired such as via network 190) can be used to distribute the reference signal configuration information amongst each other. Alternatively, a central management resource can be configured to manage, generate, and distribute the reference signal configuration information.

Yet further, as further discussed below, techniques herein generally include functionality enabling a victim gNodeB (for example, a first wireless station experiencing wireless interference) such as the wireless base station 131 to notify its neighbor aggressor gNodeB (for example, a second wireless station causing the wireless interference) such as wireless base station 132 regarding detection of CLI (Cross Link Interference) mitigation.

In this example, via communications 101 such as wireless signals transmitted from the wireless base station 132 or signals transmitted over a physical communication link or network from any suitable communication management entity, in processing operation #1, the wireless base station 131 receives reference signal configuration information 112 (a.k.a., reference signal scheduling information) associated with the wireless base station 132. In other words, the wireless base station 131 can be configured to receive the reference signal configuration information from any suitable entity in the network environment 100.

In general, and as previously discussed, the reference signal configuration information 112 indicates the particulars (such as scheduling, timing, encoding, frequency, etc., and other details) associated with the wireless base station 132 transmitting different wireless reference signals in respective wireless beams from the wireless base station 132 over time.

An example of the reference signal configuration information 112 supplied to the wireless base station 111 is shown and discussed in FIG. 4.

More specifically, FIG. 4 is an example diagram illustrating reference signal configuration information implemented by a wireless base station to transmit respective reference signals in different wireless beams as discussed herein.

As shown in FIG. 4, the reference signal configuration information 112 assigned to the wireless base station 132 and as received by the wireless base station 131 indicates that the wireless base station 132 transmits reference signal RS-B11 in the wireless beam B11, which is transmitted at a first angular direction with respect to the wireless base station 132 via antenna hardware AH32 associated with the wireless base station 132. As its name suggest, in one example, the reference signal attributes in the reference signal configuration information 112 specify unique information indicating how/when/etc. the reference signal RS-B11 is transmitted from the wireless base station 132. The reference signal attributes in the reference signal configuration information 112 can be configured to indicate: i) timing information TS1 such as indicating a particular one or more timeslots when the reference signals RS-B11 is transmitted from the wireless base station 132, ii) frequency information F1 such as indicating particular one or more wireless carrier frequencies or frequencies at which the reference signals RS-B11 is transmitted from the wireless base station 132, iii) specific one or more types of encoding such as based on one or more frequencies associated with transmitting the reference signals RS-B11, iv) preamble information P1 such as indicating a unique preamble used by the wireless base station 132 to transmit the reference signals RS-B11, etc.

Accordingly, the reference signal configuration information 112 apprises the wireless base station 131 how and when to monitor for and detect presence of the reference signals RS-B11 transmitted by the wireless base station 132 in the wireless beam B11.

The reference signal configuration information 112 assigned to the wireless base station 132 as received by the wireless base station 131 further indicates that the wireless base station 132 transmits reference signal RS-B12 in the wireless beam B12, which is transmitted at a second angular direction with respect to the wireless base station 132 via the antenna hardware AH32 of the wireless base station 132. As its name suggest, the reference signal attributes in the reference signal configuration information 112 specify unique information indicating how/when the reference signal RS-B12 is transmitted from the wireless base station 132. The reference signal attributes in the reference signal configuration information 112 can be configured to indicate: i) timing information such as a particular one or more timeslots TS2 when the reference signals RS-B12 is transmitted from the wireless base station 132, ii) frequency information F2 such as particular one or more carrier frequencies or frequencies at which the reference signals RS-B12 is transmitted from the wireless base station 132, iii) encoding information indicating specific one or more types of coding associated with transmitting the reference signals RS-B12, iv) preamble information P2 such as indicating a unique preamble used by the wireless base station 132 to transmit the reference signals RS-B12, etc.

Accordingly, the reference signal configuration information 112 apprises the wireless base station 131 how to monitor for presence of the reference signal RS-B12 transmitted by the wireless base station 132 in the wireless beam B12.

The reference signal configuration information 112 assigned to the wireless base station 132 as received by the wireless base station 131 further indicates that the wireless base station 132 transmits reference signal RS-B13 in the wireless beam B13, which is transmitted at a third angular direction with respect to the wireless base station 132 via the antenna hardware AH32 of the wireless base station 132. As its name suggest, the reference signal attributes in the reference signal configuration information 112 specify unique information indicating how/when the reference signal RS-B13 is transmitted from the wireless base station 132. The reference signal attributes in the reference signal configuration information 112 indicate: i) timing information TS3 such as indicating a particular one or more timeslots when the reference signals RS-B13 is transmitted from the wireless base station 132, ii) frequency information F1 such as particular one or more carrier frequencies or frequencies at which the reference signals RS-B13 is transmitted from the wireless base station 132, iii) encoding information such as specific one or more types of coding associated with transmitting the reference signals RS-B13, iv) preamble information P 3 such as indicating a unique preamble used by the wireless base station 132 to transmit the reference signals RS-B13, etc.

Accordingly, the reference signal configuration information 112 apprises the wireless base station 131 how to monitor for presence of the reference signal RS-B13 transmitted by the wireless base station 132 in the wireless beam B13.

The reference signal configuration information 112 assigned to the wireless base station 132 as received by the wireless base station 131 further indicates that the wireless base station 132 transmits reference signal RS-B14 in the wireless beam B14 at a fourth angular direction with respect to the wireless base station 132 via the antenna hardware AH32 associated with the wireless base station 132. As its name suggest, the reference signal attributes in the reference signal configuration information 112 specify unique information indicating how/when the reference signal RS-B14 is transmitted from the wireless base station 132. The reference signal attributes in the reference signal configuration information 112 indicate: i) timing information TS4 such as indicating a particular one or more timeslots when the reference signals RS-B14 is transmitted from the wireless base station 132, ii) frequency information F1 such as particular one or more carrier frequencies or frequencies at which the reference signals RS-B14 is transmitted from the wireless base station 132, iii) encoding information such as specific one or more types of coding associated with transmitting the reference signals RS-B14, iv) preamble information P4 such as indicating a unique preamble used by the wireless base station 132 to transmit the reference signals RS-B14, etc.

Accordingly, the reference signal configuration information 112 apprises the wireless base station 131 how to monitor for presence of the reference signal RS-B14 transmitted by the wireless base station 132 in the wireless beam B14.

Again it is noted that each of the reference signals as indicated by the reference signal configuration information 112 are unique wireless reference signals transmitted in multiple different directional wireless beams from the second wireless station 132.

Thus, for each wireless reference signal transmitted from the wireless base station 132 in a respective wireless beam, via the receipt of the reference signal configuration information 112, the wireless base station 131 is notified of how to monitor for such wireless reference signals and corresponding beams.

Referring again to FIG. 3, in processing operation #2, it is noted that the wireless base station 132 repeatedly transmits the respective reference signal RS-B11 in the directional wireless beam B11 as indicated by the reference signal configuration information 112; the wireless base station 132 repeatedly transmits the respective reference signal RS-B12 in the directional wireless beam B12 as indicated by the reference signal configuration information 112; the wireless base station 132 repeatedly transmits the respective reference signal RS-B13 in the directional wireless beam B13 as indicated by the reference signal configuration information 112; the wireless base station 132 repeatedly transmits the respective reference signal RS-B14 in the directional wireless beam B14 as indicated by the reference signal configuration information 112; and so on.

In processing operation #3, the wireless base station 131 uses the received reference signal configuration information 112 (a.k.a., schedule/signal identity information) to determine when/how one or more reference signals are scheduled for transmission from different wireless beams implemented by the wireless base station 132 to communicate in the network environment 100.

Further, in processing operation #3, the wireless base station monitors for receipt of the different wireless reference signals as indicated by the reference signal configuration information 112.

Assume in this example that the wireless base station 131 monitoring the reference signals transmitted by the wireless base station 132 detects receipt of the reference signal RS-B12 transmitted in the wireless beam B12 in the directional transmission of the wireless beam B12 from the wireless base station 132. Assume further that the wireless base station monitoring reference signals transmitted by the wireless base station does not detect receiving any of the reference signals RS-B11, RS-B13, RS-B14, etc., above a wireless power threshold level because these reference signals RS-B11, RS-B13, RS-B14, etc., are transmitted in a different direction than the wireless base station 131.

In a further example, in processing operation #3, the wireless base station 131 determines a respective wireless power level at which the reference signal RS-B12 is received by the wireless base station 131. The wireless base station 131 can be configured to compare the respective wireless power level associated with receiving one or more instances of the respective reference signal RS-B12 in processing operation #3 to a threshold level to determine the magnitude of the wireless interference caused by the wireless base station 132 transmitting the wireless beam B12.

If the magnitude of the respective wireless power level at which the reference signal RS-B12 is received by the wireless base station 132 is below the threshold level, the wireless base station 131 may consider that the wireless interference caused by the wireless base station 132 transmitting the wireless beam B12 is sufficiently insignificant that there is no need to request the wireless base station 132 to perform cross-link interference mitigation with respect to the wireless beam B12.

Conversely, if the magnitude of the respective wireless power level at which the reference signal RS-B12 is received by the wireless base station 131 is above the threshold level, the wireless base station 131 determines that the wireless interference caused by the wireless base station 132 transmitting the wireless beam B12 is sufficiently significant that there is a need to request the wireless base station 132 to perform cross-link interference mitigation with respect to the wireless beam B12.

In one example, in processing operation #4, in response to detecting the wireless interference above a threshold level, the wireless base station 131 transmits communications 103 to the wireless base station 132. The communications 103 may include a request for wireless interference mitigation.

More specifically, the requested mitigation in the communication 103 may include a request for the second wireless station 132 to adjust use of a specific and corresponding wireless beam (such as beam B12) from which the first reference signal RS-B12 and supplemental data signals are transmitted from the second wireless station 132.

In this latter instance of detecting that one or more instances of the wireless power level of receiving the reference signal RS-B12 associated with the wireless beam B12 is above the threshold level, in processing operation #4, the wireless base station 131 can be configured to initiate (e.g., request) wireless interference mitigation as caused by the wireless base station 132 transmitting the reference signal RS-B12 in the wireless beam B12. This may include the wireless base station 131 transmitting communications 103 indicating such a condition to the wireless base station 132.

The communications 103 can include any suitable information notifying the wireless base station 132 regarding the detected wireless interference caused by the reference signal RS-B12 and corresponding wireless beam B12.

In one example, the communications 103 notify the wireless base station 132 of the detected wireless interference by indicating the detection of the one or more instances of the reference signal RS-B12 received at the wireless base station 131 above a wireless power threshold level. The communications 103 may further include any suitable information (such as identity of the cell or wireless base station 132, identity of the wireless beam B12 causing the wireless interference to the wireless base station 131, identity of the received reference signal RS-B12, etc.) indicating that the wireless beam B12 as transmitted by the wireless base station 132 causes or caused wireless interference to the wireless base station 131.

Notably, each of the different directional wireless beams B11, B12, B13, B14, etc., as transmitted by the wireless base station 132 also may be used to transmit wireless communications from the wireless base station 132 to the mobile communication device 122.

Further in this example, assume that the wireless base station 132 is in wireless communication with the mobile communication device 122 (such as user equipment UE2) via the wireless communication link 127-2. Assume further that the wireless base station 131 is in wireless communication with the mobile communication device 121 (such as user equipment UE1) via the wireless communication link 127-1.

Accordingly, as previously discussed, the wireless beam B12 can be configured to support multiple purposes. For example, as previously discussed, the wireless beam B12 supports transmission of the reference signal RS-B12 from the wireless base station 132 in a second angular direction from the wireless base station 132 via the antenna hardware AH32. Additionally, the wireless beam B12 can be configured to support transmission of data over the wireless communication link 127-2 to the mobile communication device 122. The repeated transmission of the reference signals RS-B12 may be a small portion of the available wireless resources and with associated with the wireless beam B12.

If the reference signal RS-B12 transmitted in the wireless beam B12 from the wireless base station 132 causes wireless interference to the wireless base station 131, assuming that the wireless base station 132 uses a same carrier frequency to transmit data over the wireless communication link 127-2 to the mobile communication device 122, it is likely that the transmission of the data over the wireless beam B12 from the wireless base station 132 to the mobile communication device 122 also causes wireless interference to the wireless base station 131. The wireless base station 131 may be using the same wireless carrier frequency to transmit data over the wireless communication link 127-1 to the mobile communication device 121. Detected presence of the wireless reference signal RS-B12 likely indicates that the transmission of the data over wireless beam B12 from the wireless base station 132 to the mobile communication device 122 also causes wireless interference to the wireless base station 131 and possibly the mobile communication device 121.

In response to receiving the communications 103 in processing operation #4, the wireless base station 132 can perform any suitable operation to attempt to mitigate and the wireless interference that it causes to the wireless base station 131. In general, in one example, the communications 103 transmitted from the wireless station 131 to the wireless station 132 indicate that the transmission of the wireless beam B12 from the wireless station results in the wireless interference to the wireless station 131. As previously discussed, the wireless station 132 can be configured to transmit both the first reference signal RS-B12 and a data signal via the wireless beam B12, where the data signal is transmitted from the wireless station 132 via the wireless beam 122 to a wireless station such as the mobile communication device 122. Transmission of the reference signal RS-B12 supports detection of wireless interference.

More specifically, in response to receiving the communications 103 indicating a request to implement wireless interference mitigation associated with use of the wireless beam B12 by the wireless base station 132, in processing operation #5, the wireless base station 132 can be configured to perform any suitable mitigation such as reduction of a wireless power level associated with transmitting the wireless beam B12 such that the subsequent use of wireless beam B12 by the wireless base station 132 to transmit wireless signals results in the wireless interference to the wireless base station 131 falling below the threshold level.

In one example, the mitigation as discussed herein may include multiple back-and-forth communications between wireless stations to perform a stepwise reduction of a wireless power level associated with the wireless base station 132 transmitting the wireless beam B12.

For example, the wireless base station 132 can be configured to transmit a communication back to the wireless base station 131 indicating that the wireless base station 132 implemented a step reduction in the wireless power level of transmitting wireless beam B12. The wireless base station 131 may again monitor and determine a magnitude associated with receiving subsequently transmitted reference signals RS-B12 transmitted by the wireless beam B12 from the wireless base station 132. Based on the subsequent reference signals RS-B12 still being received above the wireless base station 131 above the threshold level, the wireless base station 131 may detect that the wireless interference is still too high. In such an instance, the wireless base station 131 transmits another feedback communication to the wireless base station 132 indicating detection of continued wireless interference and a further request to the wireless base station 132 to mitigate the wireless interference. The wireless base station 132 again reduces the wireless power level of transmitting the wireless B12 and continues to stepwise reduce magnitude of transmitting the wireless beam B12 until the wireless base station 131 conveys notification that the receipt of the continuously and subsequently transmitted reference signals RS-B12 in the wireless beam B12 as received by the wireless base station 131 fall below the threshold level.

Thus, in response to the wireless base station 131 detecting that the repeatedly transmitted wireless reference signals RS-B12 no longer result in wireless interference to the wireless base station 131, the wireless base station 131 transmits a respective communication to the wireless base station 132, where the communication indicates that the mitigation is completed and there is no longer a need for the wireless base station 132 to continue reducing the magnitude of transmitting wireless beam B12 and corresponding reference signal RS-B12.

In another example, the wireless beam B12 may support communications using a first wireless channel. To support mitigation of wireless channel interference, in response to receiving notification of the wireless interference in communication 103, the wireless base station 132 may switch from using the first wireless channel to using a second wireless channel to support transmission of wireless signals using the wireless beam B12. Switching use of the wireless channel used to transmit the wireless beam B12 for terminating use of the first wireless channel to transmit the first wireless beam B12 results in the wireless base station 131 no longer experiencing interference caused by the wireless base station 132.

In yet another example, in response to receiving the request from the wireless base station 131 to mitigate the detected wireless interference, the wireless base station 132 receiving the request in communications 103 can be configured to adjust the directionality of the wireless beam B12 such that adjusted directionality to a different direction reduces the amount of wireless interference it causes to the wireless base station 132.

Alternatively, even though the wireless base station 131 may request mitigation of wireless interference, the wireless base station 132 may not be able to perform any mitigation of the wireless interference caused by transmitting wireless signals from the wireless base station 132 over the wireless beam B12. In such an instance, the wireless base station 131 may need to obtain and use a different wireless channel than the wireless channel associated with the wireless beam B12.

Additional mitigation techniques are further discussed below.

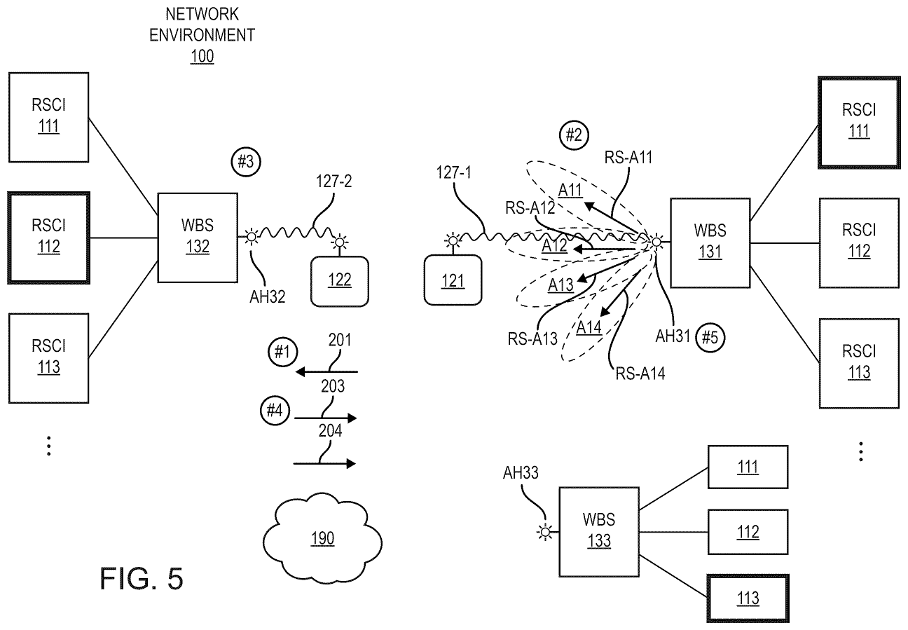

FIG. 5 is an example diagram illustrating distribution of reference signal configuration information and use of the distributed reference signal configuration information to mitigate cross-link interference amongst wireless stations as discussed herein.

As previously discussed, each of the wireless base stations in the network environment 100 is assigned corresponding reference signal configuration information indicating attributes of wireless reference signals transmitted in different beams from that particular wireless base station. Each instance of the reference signal configuration information assigned to a respective wireless base station provides notification of a schedule of the wireless base stations transmitting the respective reference signals.

In this example, assume that the wireless base station 132 is a victim of experiencing wireless interference caused by wireless communications transmitted by the wireless base station 131. As further discussed below, techniques herein generally include functionality enabling a victim gNodeB such as the wireless base station 132 to notify its neighbor aggressor gNodeB such as wireless base station 131 for CLI (Cross Link Interference) mitigation.

In this example, via communications 201 such as wireless signals transmitted from the wireless base station 131 or signals transmitted over a physical communication link or network from any suitable communication management entity, in processing operation #1, the wireless base station 132 receives reference signal configuration information 111 (a.k.a., reference signal scheduling information) associated with the wireless base station 131. In other words, the wireless base station 132 can be configured to receive the reference signal configuration information over any network or communication link from any suitable entity in the network environment 100.

In general, and as previously discussed, the reference signal configuration information 111 indicates the particulars (such as scheduling, timing, encoding, frequency, etc., and other details) associated with the wireless base station 131 transmitting different wireless reference signals in respective wireless beams from the wireless base station 131 over time.

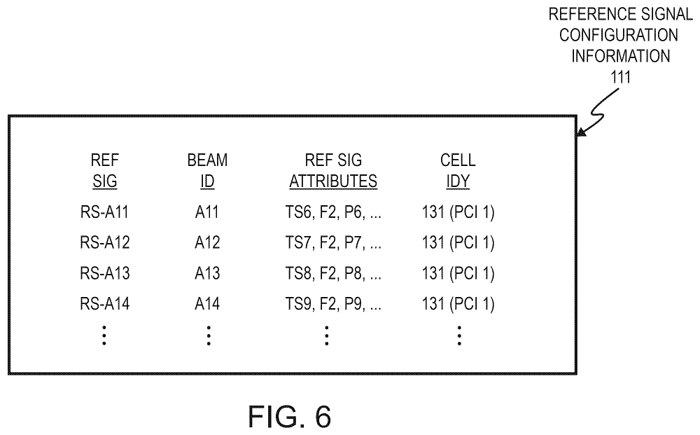

An example of the reference signal configuration information 111 supplied to the wireless base station 132 is shown and discussed in FIG. 6.

Accordingly, FIG. 6 is an example diagram illustrating reference signal configuration information implemented by a wireless base station to transmit respective reference signals in different wireless beams as discussed herein.

As shown in FIG. 6, the reference signal configuration information 111 assigned to the wireless base station 131 and as received by the wireless base station 132 indicates that the wireless base station 131 repeatedly transmits reference signal RS-A11 in the wireless beam A11, which is transmitted at a first angular direction with respect to the wireless base station 131 via antenna hardware AH31 associated with the wireless base station 131. As its name suggest, in one example, the reference signal attributes in the reference signal configuration information 111 specify unique information indicating how/when/etc. the reference signal RS-A11 is repeatedly transmitted from the wireless base station 131. The reference signal attributes in the reference signal configuration information 111 can be configured to indicate: i) timing information TS6 indicating a particular one or more timeslots when the reference signals RS-A11 are repeatedly transmitted from the wireless base station 131, ii) frequency information F2 such as indicating particular one or more wireless carrier frequencies or frequencies at which the reference signals RS-A11 are repeatedly transmitted from the wireless base station 131, iii) specific one or more types of encoding such as based on one or more frequencies associated with repeatedly transmitting the reference signals RS-A11, iv) preamble information P6 indicating a unique preamble used by the wireless base station 131 to repeatedly transmit the reference signals RS-A11, etc.

Accordingly, the reference signal configuration information 111 apprises the wireless base station 132 how to monitor for and detect presence of the reference signals RS-A11 transmitted by the wireless base station 131 in the wireless beam A11.

The reference signal configuration information 111 assigned to the wireless base station 131 as received by the wireless base station 132 further indicates that the wireless base station 131 transmits reference signal RS-A12 in the wireless beam A12, which is transmitted at a second angular direction with respect to the wireless base station 131 via the antenna hardware AH31 of the wireless base station 131. As its name suggest, the reference signal attributes in the reference signal configuration information 111 specify unique information indicating how/when the reference signal RS-A12 is transmitted from the wireless base station 131. The reference signal attributes in the reference signal configuration information 111 can be configured to indicate: i) timing information TS7 such as indicating a particular one or more timeslots when the reference signals RS-A12 is transmitted from the wireless base station 131, ii) frequency information F2 such as indicating a particular one or more carrier frequencies or frequencies at which the reference signals RS-A12 is transmitted from the wireless base station 131, iii) specific one or more types of coding associated with transmitting the reference signals RS-A12, iv) preamble information P7 such as indicating a unique preamble used by the wireless base station 131 to transmit the reference signals RS-A12, etc.

Accordingly, the reference signal configuration information 111 apprises the wireless base station 132 how to monitor for presence of the reference signal RS-A12 transmitted by the wireless base station 131 in the wireless beam A12.

The reference signal configuration information 111 assigned to the wireless base station 131 as received by the wireless base station 132 further indicates that the wireless base station 131 transmits reference signal RS-A13 in the wireless beam A13, which is transmitted at a third angular direction with respect to the wireless base station 131 via the antenna hardware AH31 of the wireless base station 131. As its name suggest, the reference signal attributes in the reference signal configuration information 111 specify unique information indicating how/when the reference signal RS-A13 is transmitted from the wireless base station 131. The reference signal attributes in the reference signal configuration information 111 indicate: i) timing information such as a particular one or more timeslots when the reference signals RS-A13 are repeatedly transmitted from the wireless base station 131, ii) frequency information such as particular one or more carrier frequencies or frequencies at which the reference signals RS-A13 are repeatedly transmitted from the wireless base station 131, iii) encoding information such as specific one or more types of coding associated with repeatedly transmitting the reference signals RS-A13, iv) a unique preamble used by the wireless base station 131 to repeatedly transmit the reference signals RS-A13, etc.

Accordingly, the reference signal configuration information 111 apprises the wireless base station 131 how to monitor for presence of the reference signal RS-A13 repeatedly transmitted by the wireless base station 131 in the wireless beam A13.

The reference signal configuration information 111 assigned to the wireless base station 131 as received by the wireless base station 132 further indicates that the wireless base station 131 transmits reference signal RS-A14 in the wireless beam A14 at a fourth angular direction with respect to the wireless base station 131 via the antenna hardware AH31 associated with the wireless base station 131. As its name suggest, the reference signal attributes in the reference signal configuration information 111 specify unique information indicating how/when the reference signal RS-A14 is transmitted from the wireless base station 131. The reference signal attributes in the reference signal configuration information 111 indicate: i) timing information such as a particular one or more timeslots when the reference signals RS-A14 are repeatedly transmitted from the wireless base station 131, ii) frequency information such as particular one or more carrier frequencies or frequencies at which the reference signals RS-A14 are repeatedly transmitted from the wireless base station 131, iii) encoding information such as specific one or more types of coding associated with repeatedly transmitting the reference signals RS-A14, iv) a unique preamble used by the wireless base station 131 to repeatedly transmit the reference signals RS-A14, etc.

Accordingly, the reference signal configuration information 111 apprises the wireless base station 132 how to monitor for presence of the reference signal RS-A14 transmitted by the wireless base station 131 in the wireless beam A14. Each of the reference signals as indicated by the reference signal configuration information 111 are unique wireless reference signals transmitted in multiple different directional wireless beams from the wireless station 131.

Thus, for each wireless reference signal transmitted from the wireless base station 131 in a respective wireless beam, the wireless base station 132 is notified of how to monitor for such wireless reference signals and corresponding beams.

Referring again to FIG. 5, in processing operation #2, it is noted that the wireless base station 131 repeatedly transmits the respective reference signal RS-A11 in the directional wireless beam A11 as indicated by the reference signal configuration information 111; the wireless base station 131 repeatedly transmits the respective reference signal RS-A12 in the directional wireless beam A12 as indicated by the reference signal configuration information 111; the wireless base station 131 repeatedly transmits the respective reference signal RS-A13 in the directional wireless beam A13 as indicated by the reference signal configuration information 111; the wireless base station 131 repeatedly transmits the respective reference signal RS-A14 in the directional wireless beam A14 as indicated by the reference signal configuration information 111; and so on.

In processing operation #3, the wireless base station 132 uses the received reference signal configuration information 111 (a.k.a., schedule/signal identity information) to determine when/how one or more reference signals are scheduled for transmission from different wireless beams implemented by the wireless base station 131 to communicate in the network environment 100.

Further, in processing operation #3, the wireless base station monitors for receipt of the different wireless reference signals as indicated by the reference signal configuration information 111.

Assume in this example that the wireless base station 132 monitoring the reference signals transmitted by the wireless base station 131 detects receipt of the reference signal RS-A12 transmitted in the wireless beam A12 in the directional transmission of the wireless beam A12 from the wireless base station 132. Assume further that the wireless base station monitoring reference signals transmitted by the wireless base station does not detect receiving any of the reference signals RS-A11, RS-A13, RS-A14, etc., above a threshold level because these reference signals are transmitted in a different direction than the wireless base station 132.

In a further example, in processing operation #3, the wireless base station 132 determines a respective wireless power level at which the reference signal RS-A12 is received by the wireless base station 132. The wireless base station 132 can be configured to compare the respective wireless power level associated with receiving one or more instances of the respective reference signal RS-A12 to a threshold level to determine the magnitude of the wireless interference caused by the wireless base station 132 transmitting the wireless beam A12.

If the magnitude of the respective wireless power level at which the reference signal RS-A12 is received by the wireless base station 132 is below the threshold level, the wireless base station 132 may consider that the wireless interference caused by the wireless base station 131 transmitting the wireless beam A12 is sufficiently insignificant that there is no need to request the wireless base station 131 to perform cross-link interference mitigation with respect to the wireless beam A12.

Conversely, if the magnitude of the respective wireless power level at which the reference signal RS-A12 is received by the wireless base station 132 is above the threshold level, the wireless base station 132 determines that the wireless interference caused by the wireless base station 131 transmitting the wireless beam A12 is sufficiently significant that there is a need to request the wireless base station 131 to perform cross-link interference mitigation with respect to the wireless beam A12.

In one example, in processing operation #4, in response to detecting the wireless interference above a threshold level, the wireless base station 132 transmits communications 203 to the wireless base station 131. The communications 203 may include a request for wireless interference mitigation.

More specifically, the requested mitigation in the communication 203 may include a request for the second wireless station 131 to adjust use of a specific and corresponding wireless beam from which the first reference signal RS-A12 and supplemental data signals are transmitted from the second wireless station 132.

In this latter instance of detecting that one or more instances of the wireless power level of receiving the reference signal RS-A12 associated with the wireless beam A12 is above the threshold level, in processing operation #4, the wireless base station 132 can be configured to initiate wireless interference mitigation as caused by the wireless base station 131 transmitting the reference signal RS-A12 in the wireless beam A12. This may include the wireless base station 132 transmitting communications 203 indicating such a condition to the wireless base station 131.

The communications 203 can include any suitable information notifying the wireless base station 131 regarding the detected wireless interference caused by the reference signal RS-A12 and corresponding wireless beam A12.

In one example, the communications 103 notify the wireless base station 131 of the detected wireless interference by indicating the detection of the one or more instances of the reference signal RS-A12 received at the wireless base station 132 above a threshold level. The communications 203 may include any suitable information (such as identity of the cell or wireless base station 131, identity of the wireless beam A12 causing the wireless interference to the wireless base station 132, identity of the received reference signal RS-A12, etc.) indicating that the wireless beam A12 as transmitted by the wireless base station 131 causes or caused wireless interference to the wireless base station 132.

Notably, each of the different directional wireless beams A11, A12, A13, A14, etc., as transmitted by the wireless base station 131 may be used to support wireless communications with one or more mobile communication devices present in the network environment 100.

Further in this example, assume that the wireless base station 132 is in wireless communication with the mobile communication device 122 (such as user equipment UE2) via the wireless communication link 127-2. Assume further that the wireless base station 131 is in wireless communication with the mobile communication device 121 (such as user equipment UE1) via the wireless communication link 127-1.

Accordingly, the wireless beam A12 can be configured to support multiple purposes. For example, as previously discussed, the wireless beam A12 supports transmission of the reference signal RS-A12 from the wireless base station 131 in a first angular direction from the wireless base station 131 via the antenna hardware AH31. Additionally, the wireless beam A12 can be configured to support transmission of data over the wireless communication link 127-1 to the mobile communication device 121. The repeated transmission of the reference signal RS-A12 may be a small portion of the available wireless resources and with associated with the wireless beam A12.

If the reference signal RS-A12 transmitted in the wireless beam A12 from the wireless base station 131 causes wireless interference to the wireless base station 132, assuming that the wireless base station 131 uses a same carrier frequency to transmit data over the wireless communication link 127-1 to the mobile communication device 121, it is likely that the transmission of the data over the wireless beam A12 from the wireless base station 131 to the mobile communication device 121 also causes wireless interference to the wireless base station 132. The wireless base station 132 may be using the same wireless carrier frequency to transmit data over the wireless communication link 127-2 to the mobile communication device 122. Detected presence of the wireless reference signal RS-A12 likely indicates that the transmission of the data over wireless beam A12 from the wireless base station 131 to the mobile communication device 121 also causes wireless interference to the wireless base station 132 and possibly the mobile communication device 122.

In response to receiving the communications 203 in processing operation #4, the wireless base station 131 can perform any suitable operation to attempt to mitigate and the wireless interference that it causes to the wireless base station 132. In general, in one example, the communications 203 transmitted from the wireless station 132 to the wireless station 131 indicate that the transmission of the wireless beam A12 from the wireless station results in the wireless interference to the wireless station 132. The wireless station 131 is operative to transmit both the first reference signal RS-A12 and a data signal via the wireless beam A12, where the data signal is transmitted from the wireless station 131 via the wireless beam A12 to a wireless station such as the mobile communication device 121.

More specifically, in response to receiving the communications 203 indicating a request to implement wireless interference mitigation associated with use of the wireless beam A12 by the wireless base station 131, in processing operation #5, the wireless base station 131 can be configured to perform any suitable mitigation such as reduction of a wireless power level associated with transmitting the wireless beam A12 such that the subsequent use of wireless beam A12 by the wireless base station 131 to transmit wireless signals results in the wireless interference to the wireless base station 132 falling below the threshold level.

In one example, the communication system herein includes multiple back-and-forth communications to perform a stepwise reduction of a wireless power level associated with the wireless base station 131 transmitting the wireless beam A12.

For example, the wireless base station 131 can be configured to transmit a communication back to the wireless base station 132 indicating that the wireless base station 131 implemented a step reduction in the wireless power level of transmitting wireless beam A12. The wireless base station 132 may again monitor and determine a magnitude associated with receiving a subsequent reference signal RS-A12 transmitted by the wireless beam A12 from the wireless base station 131. Based on the subsequent reference signal RS-A12 still being received above the wireless base station 132 above the threshold level, the wireless base station 132 may detect that the wireless interference is still too high. In such an instance, the wireless base station 132 transmits another feedback communication to the wireless base station 131 indicating a continued wireless interference and request to mitigate the wireless interference. The wireless base station 131 again reduces the wireless power level of transmitting the wireless A12 and continues to stepwise reduce magnitude of transmitting the wireless beam A12 until the wireless base station 132 provides notification to the wireless base station 131 that the receipt of the continuously and subsequently transmitted reference signals RS-A12 in the wireless beam A12 as received by the wireless base station 132 fall below the threshold level.

Thus, in response to the wireless base station 132 detecting that the repeatedly transmitted wireless reference signals RS-A12 no longer result in wireless interference to the wireless base station 132, the wireless base station 132 transmits a respective communication to the wireless base station 131, where the communication indicates that the mitigation is completed and there is no longer a need for the wireless base station 131 to continue reducing the magnitude of transmitting wireless beam A12 and corresponding reference signal RS-A12.

In another example, the wireless beam A12 may support communications in using a first wireless channel. To support mitigation of wireless channel interference, in response to receiving notification of the wireless interference in communication 103, the wireless base station 131 may switch from using the first wireless channel to using a second wireless channel to support transmission of wireless signals using the wireless beam A12. Switching use of the wireless channel used to transmit the wireless beam A12 for terminating use of the first wireless channel to transmit the first wireless beam A12 results in the wireless base station 132 no longer experiencing interference caused by the wireless base station 131.

In yet another example, in response to receiving the request to mitigate the detected wireless interference, the wireless base station 131 can be configured to adjust the directionality of the wireless beam A12 such that it reduces the amount of wireless interference it causes to the wireless base station 132.

Alternatively, even though the wireless base station 132 may request mitigation of wireless interference, the wireless base station 131 may not be able to perform any mitigation of the wireless interference caused by transmitting wireless signals from the wireless base station 132 over the wireless beam A12. In such an instance, the wireless base station 132 may need to obtain and use a different wireless channel than the wireless channel associated with the wireless beam A12.

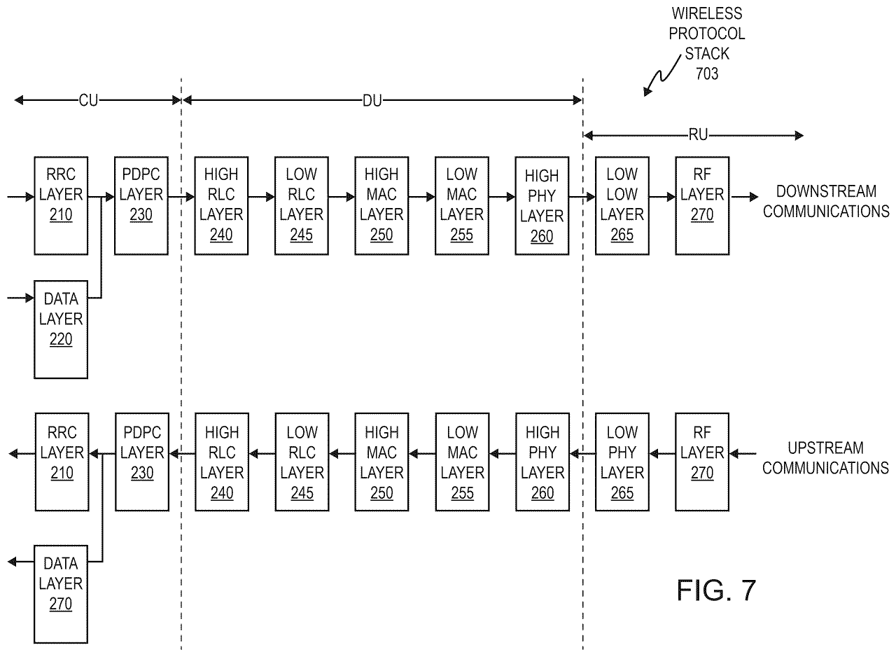

FIG. 7 is an example diagram illustrating potential split communication processing of multiple network communication layers in a protocol stack according to embodiments herein.

In one example, as shown, the hierarchy (protocol stack such as a wireless protocol stack 703) of wireless communication layers includes upper-layers, mid layers, and lower-layers.

The so-called CU (Centralized Unit) supporting layer L3 processing as discussed herein may include the RRC layer 210, Data layer 220, PDCP (Packet Data Convergence Protocol) and layer 230.

The so-called DU (Distributed Unit) supporting layer L2 processing may include high RLC (Radio Link Control) layer 240, low RLC layer 245, high MAC (Media Access Control) layer 250, low MAC layer 255, and high PHY (Physical) layer 260.

The so-called RU (Radio Unit) supporting layer L1 may include low PHY layer 265 and RF (Radio Frequency) layer 270.

Note that the partitioning of the layers associated with the different units (CU, DU, and RU) in the wireless protocol stack 703 may vary depending upon the embodiment.

A first combination of the layers in FIG. 7 supports downstream communications from a respective wireless base station to the network 190 while a second combination of layers supports upstream communications between a network and the wireless base station.

It is further noted that the previous cross-link interference mitigation techniques may be based on a respective wireless base station (gNodeB) being a monolithic gNodeB or so-called disaggregated or split wireless base station (gNodeB).

In the case where the corresponding architecture of the wireless base station is a monolithic gNodeB, the respective wireless base station implements a combination of the CU, DU, and RU at a common location, where communications between the combination of the CU/DU/RU and the network is over an Xn interface such as specified in 3GPP TS 38.423.

In the case where the corresponding architecture of the wireless base station is a disaggregated or split gNodeB, that is, where the respective wireless base station is implemented via disparately located CU and DU, the respective wireless base station implements a combination of the CU and DU at disparate locations in the network, where a respective F1 interface such as specified in 3GPP TS 38.473 supports communications between the CU and DU.

As discussed herein, the CLI mitigation and testing procedures can be modified to be sufficiently flexible enough to allow the cross-link mitigation implementation to be started/stopped at any particular point in time, to provide whatever testing parameters are necessary, and to provide the result of testing to the requesting entity. In a case where the respective CU and DU components associated with the wireless base station are aggregated (such as meaning that they are at the same general location), the conventional Xn interface and corresponding messages RESOURCE STATUS REQUEST, RESOURCE STATUS UPDATE is modified to support cross-link interference mitigation as discussed herein. Conversely, in a case where the respective CU and DU components associated with the wireless base station are disaggregated (disparately located), the conventional F1 interface and corresponding messages RESOURCE STATUS REQUEST, RESOURCE STATUS UPDATE, are implemented with appropriate modifications specific to the CLI mitigation/testing would support that functionality.

Conventional RESOURCE STATUS REQUEST messages may already include the infrastructure or capability to:
start/stop a particular request;
which cell should report the results,
which SSB should report the results;
a bitmap to identify one or more types of requests.
a field to specify the periodity of reporting, if so desired
   1.0 Configuration of gNodeB and Cross Link Interference Mitigation

Example 1 (see SECTION A below, which is associated with a co-located or aggregated CU and DU at a respective wireless base station): The existing Xn RESOURCE STATUS REQUEST and RESOURCE STATUS UPDATE, appropriately modified as proposed in SECTION A are operative to:
a) configure CLI testing measurement configuration (such as particular NZP-CSI RS, SSB, etc)
b) request CLI mitigation,
c) request CLI testing
d) report the CLI test results (such as strongest downlink beam information or a list of downlink beams and their respective measured interference power, etc) back to the requesting gNodeB.

Example 2 (see SECTION B below, which is associated with a disaggregated CU and DU implementation of a wireless base station): In case of a disaggregated gNodeB architecture, the conventional F1 interface and corresponding RESOURCE STATUS REQUEST and RESOURCE STATUS UPDATE messages may be appropriately modified as indicated in SECTION B, which is used to request CLI mitigation, request CLI testing and provide the appropriate measurement resource configuration (such as particular CSI-RS, SSB, SRS, etc), and to report the results (such as strongest downlink beam information, or a list of downlink beams and their respective measured interference power, etc) back to the requesting CU.

### 2.1 CLI Measurement Configuration

Example 3: As previously discussed, a gNodeB (wireless station) can be configured to send its respective reference signal configuration information such as configuration of its CLI testing signals to one or more neighbor wireless stations (gNodeBs) by sending a Xn RESOURCE STATUS REQUEST with:
a) the existing “Registration Request” IE set to the new value of “configure”,
b) the existing “ReportCharacteristics” IE set to the new value of “CLI testing”
c) not including any “Cell To Report List” IE
d) not including the “Reporting Periodicity” IE
e) including the new “CLI measurement configuration” IE

After a respective gNodeB1 (such as wireless base station 132) sends its “CLI measurement configuration” (i.e., such as including the configuration of its NZP-CSI RS per served cell and/or SSB signals per served beam, that will be used for any future CLI test) to a gNodeB2 (such as wireless base station 131), then gNodeB2 can measure on its own (i.e., without being requested by gNodeB1 to perform any CLI testing), the level of CLI that any of its cells and/or beams is experiencing from specific cells and/or beams of gNodeB1.

### 2.2 CLI-Mitigation Request

Example 4: A victim gNodeB can request an aggressor gNodeB to start CLI mitigation action by sending a RESOURCE STATUS REQUEST with:
a) the existing “Registration Request” IE (Information Element) set to “start”,
b) the existing “ReportCharacteristics” IE set to the new value to indicate “Mitigation Request”,
c) the existing “Cell to Report List” IE including the list of cells of the neighboring gNodeB that is causing the unwanted CLI that the victim gNodeB wants mitigated,
d) the existing “SSB to Report List” IE including the list of SSBs of the neighboring gNodeB that is causing the unwanted CLI that the victim gNodeB wants mitigated,
e) the new “CLI Mitigation information” IE which may include:
   1. in the case of cell-level testing, the affected cell ID, the CLI power measured by the victim gNodeB cell, and/or the CRI of the NZP-CSI RS Configuration information.
   2. in the case of SSB-level testing, the cell ID which contains the SSB, the affected SSB index, and the corresponding CLI Power.

Example 5: A gNodeB receiving a RESOURCE STATUS REQUEST (such as communications 103) that requests the start of “CLI Mitigation” can be configured to respond with either a RESOURCE STATUS RESPONSE, if it in fact starts mitigation actions, or a RESOURCE STATUS FAILURE, if it does not start any mitigation action.

Example 6: A gNodeB that has previously requested start of CLI mitigation, and received acknowledgment that CLI mitigation has been started, but which still detects unacceptable level of CLI can send a RESOURCE STATUS REQUEST with:
a) the existing “Registration Request” IE set to the new value of “continue”,
b) the existing “Report Characteristics” IE set to the new value to indicate “Mitigation Request”
c) the existing “Cell to Report List” and/or existing “SSB to Report List” IE, including the appropriate cells/SSBs for which it wants the next level of mitigation to be applied.

Example 7: A gNodeB that has received a RESOURCE STATUS REQUEST requesting that CLI mitigation be continued, shall respond with a RESOURCE STATUS RESPONSE, if it can or is willing to apply the next level of CLI mitigation, or with a RESOURCE STATUS FAILURE otherwise.

Example 8: A victim gNodeB that has requested CLI mitigation, and that eventually is satisfied with the level of CLI mitigation applied by the aggressor, can be configured to send a RESOURCE STATUS REQUEST to the aggressor gNodeB indicating that continued CLI mitigation is to be terminated by the aggressor gNodeB.

Proposal 9: A gNodeB receiving a RESOURCE STATUS REQUEST that requests the stop of “CLI Mitigation” shall stop the CLI mitigation actions and respond with a RESOURCE STATUS RESPONSE communicate back to the victim.

### 2.3 CLI Testing

Example 10: If a gNodeB wants to be proactive and want to start a CLI testing in order to find out how a particular configuration of its power level, antenna setting, etc., might impact neighboring gNodeBs, that aggressor gNodeB can be configured to start a CLI testing by transmitting a RESOURCE STATUS REQUEST with:
a) the existing “Registration Request” IE set to “start”,
b) the existing “Report Characteristics” IE set to the new value of bit 8 set to indicate “CLI Testing”,
c) the existing “Cell to Report List” IE including the list of cells of the neighbor gNodeB that it is requesting to perform the tests,
d) the existing “SSB to Report List” IE including the list of SSBs, if any, that it is requesting to perform the tests.
e) If configuration of the CLI testing signals had not been previously done, it can be implicitly done at the same time that CLI testing is being requested by including the new “CLI measurement configuration” IE

Example 11: If a gNodeB receives a RESOURCE STATUS REQUEST message requesting a CLI test, it can be configured to respond with a RESOURCE STATUS RESPONSE, if the recipient aggressor gNodeB can start the interference testing. If the wireless base station is unable to implement the interference testing, the gNodeB may respond by sending a RESOURCE STATUS FAILURE back to the inquiring wireless base station.

Example 12: When a first gNodeB completes a CLI testing which was requested by a neighboring second gNodeB, the first aggressor can be configured to reply to the neighboring gNodeB with a RESOURCE STATUS UPDATE message that includes the new IE “Cell CLI Resource Status”, which contains the test results of implementing the cross-link interference testing.

Example 13: The gNodeB that requested the starting of CLI testing can request that the testing be stopped, if it so desires.

### 2.4 Handling Disaggregated Architecture (Based on Using the F1 Interface and Disaggregated CU and DU)

Example 14: In the case of a disaggregated gNodeB, a corresponding CU that has received a Xn RESOURCE STATUS REQUEST requesting the start or stop of an action can be configured to send the received F1 RESOURCE STATUS REQUEST to the corresponding DU.

Example 15: In the case of a disaggregated gNodeB, a corresponding DU that has received a F1 RESOURCE STATUS REQUEST message requesting the start of an action can be configured to respond to the sending CU with either a F1 RESOURCE STATUS RESPONSE, if it in fact starts the action, or a F1 RESOURCE STATUS FAILURE, if it does not start any action.

Example 16: In the case of a disaggregated gNodeB, a corresponding DU receiving a F1 RESOURCE STATUS REQUEST that requests the stop of an action shall stop the mitigation operations and respond with a F1 RESOURCE STATUS RESPONSE.

Example 17: In the case of a disaggregated gNodeB, a CU that has received a F1 RESOURCE STATUS RESPONSE, or F1 RESOURCE STATUS FAILURE, or F1 RESOURCE STATUS UPDATE message from a DU, the CU can be configured to send, to the neighboring gNodeB, the corresponding Xn RESOURCE STATUS RESPONSE or Xn RESOURCE STATUS FAILURE or Xn RESOURCE STATUS UPDATE message, respectively.

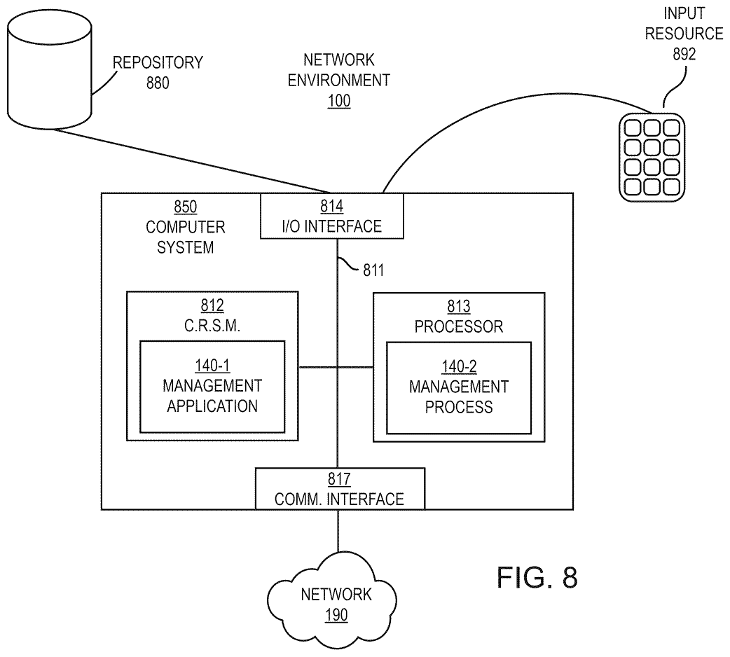

FIG. 8 is an example block diagram of a computer system for implementing any of the operations as previously discussed according to examples herein.

Any of the resources (such as wireless stations, communication management resource associated with any of wireless base station 131, wireless base station 132, wireless base station 133, . . . , mobile communication device 121, mobile communication device 122, . . . , etc.) as discussed herein can be configured to include computer processor hardware and/or corresponding executable instructions to carry out the different operations as discussed herein via computer system 850.

As shown, computer system 850 of the present example includes an interconnect 811 coupling computer readable storage media 812 such as a non-transitory type of media (or more generally, computer readable hardware which can be any suitable type of hardware storage medium in which digital information can be stored and retrieved), a processor 813 (computer processor hardware), I/O interface 814, and a communications interface 817.

I/O interface(s) 814 supports connectivity to repository 880 and input resource 892.

Computer readable storage medium 812 (such as computer readable hardware or other suitable entity) can be any hardware storage device such as memory, optical storage, hard drive, floppy disk, etc. In one example, the computer readable storage medium 812 stores instructions and/or data.

As shown, computer readable storage media 812 can be encoded with management application 140-1 (e.g., including instructions) to carry out any of the operations as discussed herein.

During operation of one example, processor 813 accesses computer readable storage media 812 via the use of interconnect 811 in order to launch, run, execute, interpret or otherwise perform the instructions in management application 140-1 stored on computer readable storage medium 812. Execution of the management application 140-1 produces management process 140-2 to carry out any of the operations and/or processes as discussed herein.

Those skilled in the art will understand that the computer system 850 can include other processes and/or software and hardware components, such as an operating system that controls allocation and use of hardware resources to execute management application 140-1.

In accordance with different examples, note that computer system may reside in any of various types of devices, including, but not limited to, a mobile computer, a personal computer system, wireless station, connection management resource, a wireless device, a wireless access point, a access point, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein. In one example, the control system 850 can include or be implemented in virtualization environments such as the cloud.

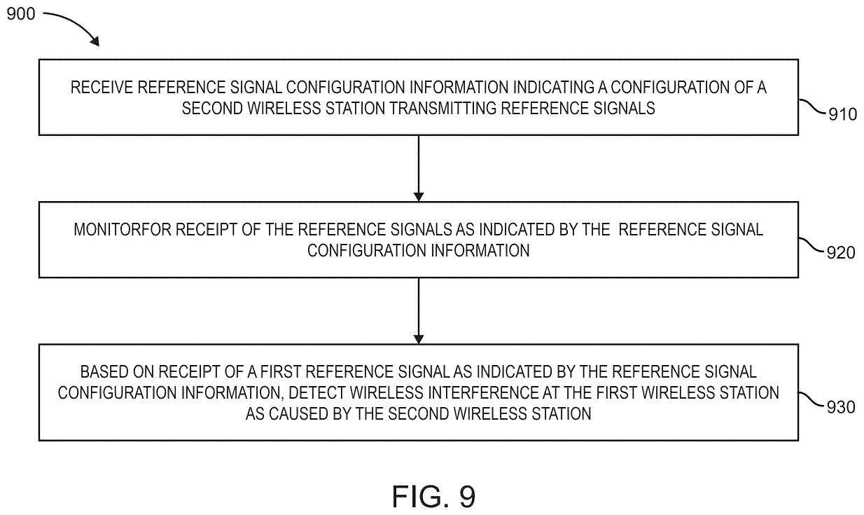

Functionality supported by the different resources will now be discussed via flowchart in FIG. 9.

FIG. 9 is a flowchart 900 illustrating an example method according to examples. Note that flowchart 900 overlaps/captures general concepts as discussed herein.

In processing operation 910, the first wireless station receives reference signal configuration information indicating a configuration of a second wireless station transmitting reference signals.

In processing operation 920, the first wireless station monitors for receipt of the reference signals as indicated by the reference signal configuration information.

In processing operation 930, based on receipt of a first reference signal as indicated by the reference signal configuration information, the first wireless station detects wireless interference at the first wireless station as caused by the second wireless station.

### Section A—Changes to XnAP Messages (XN Interface—Aggregated CU and DU at the Wireless Base Station)

### Section A Part 1—Resource Status Request

This message is sent by NG-RAN node₁ to NG-RAN node₂ to initiate the requested measurement according to the parameters given in the message.

Direction: NG-RAN node₁→NG-RAN node₂.

TABLE 1

| IE/Group | | | IE type and | Semantics | Assigned |
|---|---|---|---|---|---|
| Name | Presence | Range | reference | description | Criticality |
| Message Type | M | | 9.2.3.1 | | reject |
| NG-RAN | M | | INTEGER | Allocated by | reject |
| node1 | | | (1 . . . 4095, . . .) | NG-RAN | |
| Measurement | | | | node₁ | |
| ID | | | | | |
| NG-RAN | C- | | INTEGER | Allocated by | ignore |
| node2 | ifRegistrationRequestStoporAdd | | (1 . . . 4095, . . .) | NG-RAN | |
| Measurement | | | | node₂ | |
| ID | | | | | |
| Registration | M | | ENUMERATED(start, | Type of | reject |
| Request | | | stop, | request for | |
| | | | add, | which the | |
| | | | continue, | resource | |
| | | | configure, . . .) | status is | |
| | | | | required. | |
| Report | C- | | BITSTRING | Each position | reject |
| Characteristics | ifRegistrationRequestStart | | (SIZE(32)) | in the bitmap | |
| | | | | indicates | |
| | | | | measurement | |
| | | | | object the | |
| | | | | NG-RAN | |
| | | | | node2 is | |
| | | | | requested to | |
| | | | | report. | |
| | | | | First Bit = | |
| | | | | PRB Periodic, | |
| | | | | Second Bit = | |
| | | | | TNL Capacity | |
| | | | | Ind Periodic, | |
| | | | | Third Bit = | |
| | | | | Composite | |
| | | | | Available | |
| | | | | Capacity | |
| | | | | Periodic, | |
| | | | | Fourth Bit = | |
| | | | | Number of | |
| | | | | Active UEs | |
| | | | | Periodic, | |
| | | | | Fifth Bit = | |
| | | | | RRC | |
| | | | | connections | |
| | | | | Periodic, | |
| | | | | Sixth Bit = | |
| | | | | NR-U | |
| | | | | Channel List | |
| | | | | Periodic. | |
| | | | | Seventh Bit = | |
| | | | | CLI | |
| | | | | TestingEighth | |
| | | | | Bit = CLI | |
| | | | | Mitigation | |
| | | | | Other bits | |
| | | | | shall be | |
| | | | | ignored by | |
| | | | | the NG-RAN | |
| | | | | node2. | |
| Cell To Report | | 0 . . . 1 | | Cell ID list to | ignore |
| List | | | | which the | |
| | | | | request | |
| | | | | applies. | |
| >Cell To | | 1 . . . | | | |
| Report Item | | <maxnoofCellsinNG-RANnode> | | | |
| >>Cell ID | M | | Global NG- | | |
| | | | RAN Cell | | |
| | | | Identity | | |
| | | | 9.2.2.27 | | |
| >>CLI | C- | | 9.2.2.x | | |
| Mitigation | ifMitigationRequestStartCont | | | | |
| information | | | | | |
| >>SSB To | | 0 . . . 1 | | SSB list to | |
| Report List | | | | which the | |
| | | | | request | |
| | | | | applies. | |
| >>>SSB To | | 1 . . . | | | |
| Report Item | | <maxnoofSSBAreas> | | | |
| >>>>SSB- | M | | INTEGER | | |
| Index | | | (0 . . . , 63 . . .) | | |
| >>>>CLI | C- | | 9.2.2.x | | |
| Mitigation | ifMitigationRequestStartCont | | | | |
| information | | | | | |
| >>Slice To | | 0 . . . 1 | | S-NSSAI list | |
| Report List | | | | to which the | |
| | | | | request | |
| | | | | applies. | |
| >>>Slice | | 1 . . . | | | |
| To Report | | <maxnoofBPLMNs> | | | |
| Item | | | | | |
| >>>>PLMN | M | | 9.2.2.4 | Broadcast | |
| Identity | | | | PLMN | |
| >>>>S- | | 1 | | | |
| NSSAI | | | | | |
| List | | | | | |
| >>>>>S- | | 1 . . . | | | |
| NSSAI | | <maxnoofSliceItems> | | | |
| Item | | | | | |
| >>>>>> | M | | 9.2.3.21 | | |
| S-NSSAI | | | | | |
| Reporting | O | | ENUMERATED(500 ms, | Periodicity | Ignore |
| Periodicity | | | 1000 ms, | that can be | |
| | | | 2000 ms, | used for | |
| | | | 5000 ms, | reporting of | |
| | | | 10000 ms, | indicated | |
| | | | . . .) | measurements. | |
| | | | | Also used | |
| | | | | as the | |
| | | | | averaging | |
| | | | | window | |
| | | | | length for all | |
| | | | | measurement | |
| | | | | object if | |
| | | | | supported. | |
| | | | | This IE is | |
| | | | | ignored if the | |
| | | | | Registration | |
| | | | | Request IE is | |
| | | | | set to “add”. | |
| CLI | C- | | 9.2.2.y | | ignore |
| Measurement | ifConfigStartCLITesting | | | | |
| Configuration | | | | | |

### Section A Part 2

TABLE 2

| | Explanation |
|---|---|
| Condition | |
| ifRegistrationRequestStoporAdd | This IE shall be present if the |
| | Registration Request IE is set to the |
| | value “stop” or “add”. |
| ifRegistrationRequestStart | This IE shall be present if the |
| | Registration Request IE is set to the |
| | value “start”. |
| ifConfigStartCLITesting | This IE shall be present if the |
| | RegistrationRequest has the values |
| | “Configure”, or “Start”, and the |
| | ReportCharacteristics IE is set to the |
| | value “CLI Testing” |
| ifMitigationRequestStartCont | This IE shall be present if the Report |
| | Characteristics IE is set to “CLI |
| | Mitigation” AND the Registration |
| | Request IE is set to either “start” or |
| | “continue”. |
| Range bound | |
| maxnoofCellsinNG-RANnode | Maximum no. cells that can be served |
| | by a NG-RAN node. Value is 16384. |
| maxnoofSSBAreas | Maximum no. SSB Areas that can be |
| | served by a NG-RAN node cell. Value |
| | is 64. |
| maxnoofSliceItems | Maximum no. of signalled slice support |
| | items. Value is 1024. |

### Section A Part 3 Resource Status Update

This message is sent by NG-RAN node₂ to NG-RAN node₁ to report the results of the requested measurements.

Direction: NG-RAN node₂→NG-RAN node₁.

TABLE 3

| | | | IE type and | Semantics | Assigned |
|---|---|---|---|---|---|
| IE/Group Name | Presence | Range | reference | description | Criticality |
| Message Type | M | | 9.2.3.1 | | ignore |
| NG-RAN node1 | M | | INTEGER | Allocated by | reject |
| Measurement ID | | | (1 . . . 4095, . . .) | NG-RAN | |
| | | | | node₁ | |
| NG-RAN node2 | M | | INTEGER | Allocated by | reject |
| Measurement ID | | | (1 . . . 4095, . . .) | NG-RAN | |
| | | | | node₂ | |
| Cell Measurement | | 1 | | | ignore |
| Result | | | | | |
| >Cell | | 1 . . . | | | ignore |
| Measurement | | <maxnoofCellsinNG- | | | |
| Result Item | | RANnode> | | | |
| >>Cell ID | M | | Global NG- | | |
| | | | RAN Cell | | |
| | | | Identity | | |
| | | | 9.2.2.27 | | |
| >> CLI Resource | O | | 9.2.2.z | | |
| Status | | | | | |
| >>Radio | O | | 9.2.2.50 | | |
| Resource Status | | | | | |
| >>TNL Capacity | O | | 9.2.2.49 | | |
| Indicator | | | | | |
| >>Composite | O | | 9.2.2.51 | | |
| Available | | | | | |
| Capacity Group | | | | | |
| >>Slice | O | | 9.2.2.55 | | |
| Available | | | | | |
| Capacity | | | | | |
| >>Number of | O | | 9.2.2.62 | | |
| Active UEs | | | | | |
| >>RRC | O | | 9.2.2.56 | | |
| Connections | | | | | |
| >>NR-U | | 0 . . . 1 | | | ignore |
| Channel List | | | | | |
| >>>NR-U | | 1 . . . | | | |
| Channel Item | | <maxnoofNR- | | | |
| | | UChannelIDs> | | | |
| >>>>NR-U | M | | INTEGER | The NR-U | |
| Channel ID | | | (1 . . . | channel | |
| | | | maxnoofNR- | utilised in the | |
| | | | UchannelIDs, | last reporting | |
| | | | . . . ) | period | |
| >>>>Channel | M | | INTEGER | The | |
| occupancy | | | (0 . . . 100) | percentage of | |
| time | | | | time for which | |
| percentage DL | | | | the channel | |
| | | | | resources | |
| | | | | have been | |
| | | | | utilised for DL | |
| | | | | traffic served | |
| | | | | by the | |
| | | | | corresponding | |
| | | | | NR-U | |
| | | | | Channel of | |
| | | | | the serving | |
| | | | | cell. Value | |
| | | | | 100 indicates | |
| | | | | that the | |
| | | | | channel | |
| | | | | resources | |
| | | | | have been | |
| | | | | utilized for DL | |
| | | | | traffic served | |
| | | | | by the | |
| | | | | corresponding | |
| | | | | NR-U | |
| | | | | Channel of | |
| | | | | the serving | |
| | | | | cell for the | |
| | | | | whole | |
| | | | | duration | |
| | | | | between | |
| | | | | consecutive | |
| | | | | reporting. | |
| >>>>Energy | M | | INTEGER | Average ED | |
| Detection | | | (−100 . . . −50, . . .) | Threshold | |
| Threshold DL | | | | used for DL | |
| | | | | channel | |
| | | | | sensing at the | |
| | | | | gNB. Value is | |
| | | | | in dBm. | |
| >>>>Channel | O | | INTEGER | The | ignore |
| Occupancy | | | (0 . . . 100) | percentage of | |
| Time | | | | time for which | |
| Percentage UL | | | | the channel | |
| | | | | resources | |
| | | | | have been | |
| | | | | utilised for UL | |
| | | | | traffic served | |
| | | | | by the | |
| | | | | corresponding | |
| | | | | NR-U | |
| | | | | Channel of | |
| | | | | the serving | |
| | | | | cell for UEs | |
| | | | | that transmit | |
| | | | | to the serving | |
| | | | | cell. Value | |
| | | | | 100 indicates | |
| | | | | that the | |
| | | | | channel | |
| | | | | resources | |
| | | | | have been | |
| | | | | utilized for UL | |
| | | | | traffic served | |
| | | | | by the | |
| | | | | corresponding | |
| | | | | NR-U | |
| | | | | Channel of | |
| | | | | the serving | |
| | | | | cell for the | |
| | | | | whole | |
| | | | | duration | |
| | | | | between | |
| | | | | consecutive | |
| | | | | reporting. | |
| >>>>Energy | O | | INTEGER | Indicates the | ignore |
| Detection | | | (−100 . . . −50, . . .) | average of | |
| Threshold UL | | | | the maximum | |
| | | | | ED Threshold | |
| | | | | configured by | |
| | | | | the gNB for | |
| | | | | UL channel | |
| | | | | sensing. | |
| | | | | Value is in | |
| | | | | dBm. | |
| >>>>Radio | O | | 9.2.2.104 | Indicates the | Ignore |
| Resource | | | | radio | |
| Status NR-U | | | | resource | |
| | | | | status per | |
| | | | | NR-U | |
| | | | | channel. | |

TABLE 4

| Range bound | Explanation |
|---|---|
| maxnoofCellsinNG-RANnode | Maximum no. cells that can be served by a |
| | NG-RAN node. Value is 16384. |
| maxnoofNR-UchannelIDs | Maximum no. NR-U channel IDs in a cell. |
| | Value is 16. |

### Section A Part 4

### CLI Mitigation Information

This IE (information element) contains information that may be used to mitigate CLI across gNBs.

TABLE 5

| | | | IE type and | Semantics |
|---|---|---|---|---|
| IE/Group Name | Presence | Range | reference | description |
| CLI Information | | | | |
| >CLI Power | M | [0 . . . | INTEGER | Number of dBm |
| detected | | X] | (0 . . . X) | of CLI power |
| >CRI | O | | INTEGER | Includes the CSI- |
| | | | (1 . . . 64) | RS Resource |
| | | | | Indicator (CRI) |
| | | | | value. CRI is an |
| | | | | index indicating a |
| | | | | CSI-RS resource |
| | | | | within a set of |
| | | | | resources |
| >SSB Index | O | | INTEGER | Identifier of the |
| | | | (0 . . . 63) | SSB beam. |

### Section A PART 5—CLI Measurement Configuration

TABLE 6

| | | | IE type and | Semantics |
|---|---|---|---|---|
| IE/Group Name | Presence | Range | reference | description |
| CLITestType | M | ENUMERATED(gNB- | | |
| | | to-gNB, . . .) | | |
| ServedCellList | 1 . . . | | | |
| | <maxnoofCellsinNG- | | | |
| | RANnode> | | | |
| >ServedCellItem | M | | | |
| >>NZP-CSI-RS | M | | 9.2.2.w | |
| Configuration | | | | |
| >>SSBCLIList | 0 . . . 1 | | | |
| >>SSBCLIItem | 1 . . . | | | |
| | <maxnoofSSBAreas> | | | |
| >>SSB- | M | | | Coding to |
| Specification | | | | be agreed |

TABLE 7

| Range bound | Explanation |
|---|---|
| maxnoofSSBAreas | Maximum no. SSB Areas that can be served by a |
| | gNB node cell. Value is 64. |

### Section A Part 6—CLI Resource Status

This IE contains information about the CLI test result

TABLE 8

| | | | IE type and | Semantics |
|---|---|---|---|---|
| IE/Group Name | Presence | Range | reference | description |
| CHOICE Report Level | | | | |
| >cell_based | | | | |
| >>CLI Power | M | [0 . . . X] | INTEGER | Number of dBm |
| | | | (0 . . . X) | of CLI power |
| >>CRI | M | | INTEGER(1 | The CSI-RS |
| | | | . . . 64) | Resource |
| | | | | Indicator (CRI) |
| | | | | value, i.e the |
| | | | | index of a CSI- |
| | | | | RS resource |
| | | | | within a set of |
| | | | | resources of the |
| | | | | NZP-CSI-RS |
| | | | | configured by |
| | | | | the aggressor. |
| >SSB_based | | | | |
| >> SSB Area CLI List | 0 . . . 1 | | | |
| >>> SSB Area CLI | 1 . . . | | | |
| Item | <maxnoofSSBAreas> | | | |
| >>>>SSB Index | M | | INTEGER(0 | |
| | | | . . . 63) | |
| >>>>CLI Power | M | [0 . . . X] | INTEGER | Number of dBm |
| | | | (0 . . . X) | of CLI power |

TABLE 9

| Range bound | Explanation |
|---|---|
| maxnoofSSBAreas | Maximum no. SSB Areas that can be served by a |
| | gNB node cell. Value is 64. |

### Section A Part 7—NZP-CSI-RS Configuration

This IE contains information describing the NZP-CSI-RS configuration for a cell.

TABLE 10

| | | | IE type and | Semantics |
|---|---|---|---|---|
| IE/Group Name | Presence | Range | reference | description |
| NZP-CSI-RS- | M | | OCTET | Includes the |
| ResourceSet | | | STRING | NZP-CSI-RS- |
| | | | | ResourceSet IE, |
| | | | | as defined in TS |
| | | | | 38.331 [10]. |
| NZP-CSI-RS-Resource | | 1 | | List of CLI |
| List | | | | mitigation |
| | | | | assistance |
| | | | | information per |
| | | | | cell |
| >NZP-CSI-RS-Resource | | 1 . . . | | |
| Item | | <maxnoofNZP- | | |
| | | CSI-RS- | | |
| | | RESOURCE> | | |
| >>NZP-CSI-RS- | M | | OCTET | Includes the |
| Resource | | | STRING | NZP-CSI-RS- |
| | | | | Resource IE, as |
| | | | | defined in TS |
| | | | | 38.331 [10]. |

TABLE 11

| Range bound | Explanation |
|---|---|
| maxnoofNZP-CSI-RS- | Maximum no. of NZP-CSI-RS-Resoures. |
| RESOURCE | Value is 64. |

Section B—Changes to F1 AP (F1 Interface-Disaggregated CU and DU Associated with the Wireless Base Station)

### Part 1—Resource Status Request

This message is sent by gNB-CU to gNB-DU to initiate the requested measurement according to the parameters given in the message.

Direction: gNB-CU→gNB-DU.

TABLE 12

| | | | IE type | | |
|---|---|---|---|---|---|
| | | | and | Semantics | Assigned |
| IE/Group Name | Presence | Range | reference | description | Criticality |
| Message Type | M | | 9.3.1.1 | | reject |
| Transaction ID | M | | 9.3.1.23 | | reject |
| gNB-CU | M | | INTEGER | Allocated by | reject |
| Measurement ID | | | (0 . . . 4095, . . .) | gNB-CU | |
| gNB-DU | C- | | INTEGER | Allocated by | ignore |
| Measurement ID | ifRegistrationRequestStoporAdd | | (0 . . . 4095, . . . | gNB-DU | |
| | | | ) | | |
| Registration | M | | ENUMERATED(start, | Type of | ignore |
| Request | | | stop, add, | request for | |
| | | | continue, | which the | |
| | | | configure, | resource | |
| | | | . . .) | status is | |
| | | | | required. | |
| Report | C- | | BIT | Each position | ignore |
| Characteristics | ifRegistrationRequestStart | | STRING | in the bitmap | |
| | | | (SIZE(32)) | indicates | |
| | | | | measurement | |
| | | | | object the | |
| | | | | gNB-DU is | |
| | | | | requested to | |
| | | | | report. | |
| | | | | First Bit = PRB | |
| | | | | Periodic, | |
| | | | | Second Bit = | |
| | | | | TNL Capacity | |
| | | | | Ind Periodic, | |
| | | | | Third Bit = | |
| | | | | Composite | |
| | | | | Available | |
| | | | | Capacity | |
| | | | | Periodic, | |
| | | | | Fourth Bit = | |
| | | | | HW LoadInd | |
| | | | | Periodic, | |
| | | | | Fifth Bit = | |
| | | | | Number of | |
| | | | | Active UEs | |
| | | | | Periodic, | |
| | | | | Sixth Bit = | |
| | | | | NR-U Channel | |
| | | | | List Periodic. | |
| | | | | Seventh Bit = | |
| | | | | CLI Testing | |
| | | | | Eight Bit = CLI | |
| | | | | Mitigation | |
| | | | | Other bits | |
| | | | | shall be | |
| | | | | ignored by the | |
| | | | | gNB-DU. | |
| Cell To Report | | 0 . . . 1 | | Cell ID list to | ignore |
| List | | | | which the | |
| | | | | request | |
| | | | | applies. | |
| >Cell To Report | | 1 . . . | | | |
| Item | | <maxCellingNBDU> | | | |
| >>Cell ID | M | | NR CGI | | |
| | | | 9.3.1.12 | | |
| >>CLI | C- | | 9.2.2.x | | |
| Mitigation | ifMitigationRequestStartCont | | | | |
| information | | | | | |
| >>SSB To | | 0 . . . 1 | | SSB list to | |
| Report List | | | | which the | |
| | | | | request | |
| | | | | applies. | |
| >>>SSB To | | 1 . . . | | | |
| Report Item | | <maxnoofSSBAreas> | | | |
| >>>>SSB | M | | INTEGER | | |
| index | | | (0 . . . 63) | | |
| >>>>CLI | C- | | 9.2.2.x | | |
| Mitigation | ifMitigationRequestStartCont | | | | |
| information | | | | | |
| >>Slice To | | 0 . . . 1 | | S-NSSAI list | |
| Report List | | | | to which the | |
| | | | | request | |
| | | | | applies. | |
| >>>Slice To | | 1 . . . | | | |
| Report Item | | <maxnoofBPLMNsNR> | | | |
| >>>>PLMN | M | | 9.3.1.14 | Broadcast | |
| Identity | | | | PLMN | |
| >>>>S- | | 1 | | | |
| NSSAI List | | | | | |
| >>>>>S- | | 1 . . . | | | |
| NSSAI Item | | <maxnoofSliceItems> | | | |
| >>>>>>S- | M | | 9.3.1.38 | | |
| NSSAI | | | | | |
| Reporting | O | | ENUMERATED(500 ms, | Periodicity that | ignore |
| Periodicity | | | 1000 ms, | can be used | |
| | | | 2000 ms, | for reporting of | |
| | | | 5000 ms, | indicated | |
| | | | 10000 ms, | measurements. | |
| | | | . . .) | Also used | |
| | | | | as the | |
| | | | | averaging | |
| | | | | window length | |
| | | | | for all | |
| | | | | measurement | |
| | | | | object if | |
| | | | | supported. | |
| | | | | This IE is | |
| | | | | ignored if the | |
| | | | | Registration | |
| | | | | Request IE is | |
| | | | | set to “add”. | |
| CLI Measurement | C- | | 9.3.1.y | | ignore |
| Configuration | ifCLITesting | | | | |

TABLE 13

| Condition | Explanation |
|---|---|
| ifRegistrationRequestStoporAdd | This IE shall be present if the Registration |
| | Request IE is set to the value “stop” or “add”. |
| ifRegistrationRequestStart | This IE shall be present if the Registration |
| | Request IE is set to the value “start”. |
| ifConfigStartCLITesting | This IE shall be present if the |
| | RegistrationRequest has the values |
| | “Configure”, or “Start”, and the |
| | ReportCharacteristics IE is set to the value |
| | “CLI Testing” |
| ifMitigationRequestStartCont | This IE shall be present if the Report |
| | Characteristics IE is set to “CLI Mitigation” |
| | AND the Registration Request IE is set to |
| | either “start” or “continue”. |

| Range bound | Explanation |
|---|---|
| maxCellingNBDU | Maximum no. cells that can be served by a gNB- |
| | DU. Value is 512. |
| maxnoofSSBAreas | Maximum no. SSB Areas that can be served by a |
| | gNB node cell. Value is 64. |
| maxnoofSliceItems | Maximum no. of signalled slice support items. |
| | Value is 1024. |
| maxnoofBPLMNsNR | Maximum no. of PLMN Ids.broadcast in a cell. |
| | Value is 12. |

### Section B Part 2—Resource Status Update

This message is sent by gNB-DU to gNB-CU to report the results of the requested measurements.

Direction: gNB-DU→gNB-CU.

TABLE 14

| | | | IE type and | Semantics | Assigned |
|---|---|---|---|---|---|
| IE/Group Name | Presence | Range | reference | description | Criticality |
| Message Type | M | | 9.3.1.1 | | ignore |
| Transaction ID | M | | 9.3.1.23 | | reject |
| gNB-CU | M | | INTEGER | Allocated by | reject |
| Measurement ID | | | (0 . . . 4095, . . .) | gNB-CU | |
| gNB-DU | M | | INTEGER | Allocated by | ignore |
| Measurement ID | | | (0 . . . 4095, . . .) | gNB-DU | |
| Hardware Load | O | | 9.3.1.136 | | ignore |
| Indicator | | | | | |
| TNL Capacity | O | | 9.3.1.128 | | ignore |
| Indicator | | | | | |
| Cell | | 0 . . . 1 | | | ignore |
| Measurement | | | | | |
| Result | | | | | |
| >Cell | | 1 . . . | | | |
| Measurement | | <maxCellingNBDU> | | | |
| Result Item | | | | | |
| >>Cell ID | M | | NR CGI | | |
| | | | 9.3.1.12 | | |
| >> CLI | O | | 9.3.1.z | | |
| Resource | | | | | |
| Status | | | | | |
| >>Radio | O | | 9.3.1.129 | | |
| Resource | | | | | |
| Status | | | | | |
| >>Composite | O | | 9.3.1.130 | | |
| Available | | | | | |
| Capacity Group | | | | | |
| >>Slice | O | | 9.3.1.134 | | |
| Available | | | | | |
| Capacity | | | | | |
| >>Number of | O | | 9.3.1.135 | | |
| Active UEs | | | | | |
| >>NR-U | | 0 . . . 1 | | | ignore |
| Channel List | | | | | |
| >>>NR-U | | 1 . . . | | | |
| Channel Item | | <maxnoofNR- | | | |
| | | UChannelIDs> | | | |
| >>>>NR-U | M | | INTEGER | Identifies a | |
| Channel ID | | | (1 . . . | portion of the | |
| | | | maxnoofNR- | NR-U | |
| | | | UChannelIDs) | Channel | |
| | | | | Bandwidth on | |
| | | | | which channel | |
| | | | | access | |
| | | | | procedure in | |
| | | | | shared | |
| | | | | spectrum has | |
| | | | | been performed | |
| | | | | in the last | |
| | | | | reporting | |
| | | | | period. | |
| >>>>Channel | M | | INTEGER | The percentage | |
| Occupancy | | | (0 . . . 100) | of time for | |
| Time | | | | which the | |
| Percentage | | | | channel resources | |
| DL | | | | have been | |
| | | | | utilised for DL | |
| | | | | traffic served | |
| | | | | by the | |
| | | | | corresponding | |
| | | | | NR-U Channel of | |
| | | | | the serving | |
| | | | | cell. Value | |
| | | | | 100 indicates | |
| | | | | that the channel | |
| | | | | resources have | |
| | | | | been utilized for | |
| | | | | DL traffic | |
| | | | | served by the | |
| | | | | corresponding | |
| | | | | NR-U Channel of | |
| | | | | the serving | |
| | | | | cell for the | |
| | | | | whole duration | |
| | | | | between | |
| | | | | consecutive | |
| | | | | reporting. | |
| >>>>Energy | M | | INTEGER (−100 | Average ED | |
| Detection | | | . . . −50, . . .) | Threshold | |
| Threshold DL | | | | used for DL | |
| | | | | channel | |
| | | | | sensing at the | |
| | | | | gNB. Value is | |
| | | | | in dBm. | |
| >>>>Channel | O | | INTEGER | The percentage | ignore |
| Occupancy | | | (0 . . . 100) | of time for | |
| Time | | | | which the channel | |
| Percentage | | | | resources | |
| UL | | | | have been | |
| | | | | utilised for UL | |
| | | | | traffic served | |
| | | | | by the | |
| | | | | corresponding | |
| | | | | NR-U Channel of | |
| | | | | the serving | |
| | | | | cell for UEs | |
| | | | | that transmit | |
| | | | | to the serving | |
| | | | | cell. Value | |
| | | | | 100 indicates | |
| | | | | that the channel | |
| | | | | resources | |
| | | | | have been | |
| | | | | utilized for UL | |
| | | | | traffic served | |
| | | | | by the | |
| | | | | corresponding | |
| | | | | NR-U Channel of | |
| | | | | the serving | |
| | | | | cell for the | |
| | | | | whole duration | |
| | | | | between | |
| | | | | consecutive | |
| | | | | reporting. | |
| >>>>Radio | O | | 9.3.1.295 | Indicates the | ignore |
| Resource | | | | radio resource | |
| Status NR-U | | | | status per | |
| | | | | NR-U channel. | |

TABLE 15

| Range bound | Explanation |
|---|---|
| maxCellingNBDU | Maximum no. cells that can be served by a |
| | gNB-DU. Value is 512. |
| maxnoofNR-UChannelIDs | Maximum no. NR-U Channel IDs in a cell. |
| | Value is 16. |

Section B Part 2—CLI Mitigation information

This IE contains information that may be used to mitigate CLI across gNBs.

TABLE 16

| | | | IE type and | Semantics |
|---|---|---|---|---|
| IE/Group Name | Presence | Range | reference | description |
| CLI Information | | | | |
| >CLI Power detected | M | [0 . . . X] | INTEGER | Number of dBm |
| | | | (0 . . . X) | of CLI power |
| >CRI | O | | INTEGER | Includes the |
| | | | (1 . . . 64) | CSI-RS |
| | | | | Resource |
| | | | | Indicator (CRI) |
| | | | | value. CRI is an |
| | | | | index indicating |
| | | | | a CSI-RS |
| | | | | resource within |
| | | | | a set of |
| | | | | resources |
| >SSB Index | O | | INTEGER | Identifier of the |
| | | | (0 . . . 63) | SSB beam. |

### Section B Part 3—CLI Test Parameters

TABLE 17

| | | | IE type and | Semantics |
|---|---|---|---|---|
| IE/Group Name | Presence | Range | reference | description |
| CLITestType | M | ENUMERATED(gNB- | | |
| | | to-gNB, . . .) | | |
| ServedCellCLIList | 1 . . . | | | |
| | <maxnoofCellsinNG- | | | |
| | RANnode> | | | |
| >ServedCellCLIItem | M | | | |
| >>NZP-CSI-RS | M | | 9.3.1.w | |
| Configuration | | | | |
| >>SSBCLIList | 0 . . . 1 | | | |
| >>SSBCLIItem | 1 . . . | | | |
| | <maxnoofSSBAreas> | | | |
| >>SSB-Configuration | M | | | Coding to be |
| | | | | agreed |

TABLE 18

| Range bound | Explanation |
|---|---|
| maxnoofSSBAreas | Maximum no. SSB Areas that can be served by a |
| | gNB node cell. Value is 64. |

### Section B Part 3—CLI Resource Status

This IE contains information about the CLI test result

TABLE 19

| | | | IE type and | Semantics |
|---|---|---|---|---|
| IE/Group Name | Presence | Range | reference | description |
| CHOICE Report Level | | | | |
| >cell_based | | | | |
| >>CLI Power | M | [0 . . . X] | INTEGER | Number of dBm |
| | | | (0 . . . X) | of CLI power |
| >>CRI | M | | INTEGER(1 | The CSI-RS |
| | | | . . . 64) | Resource |
| | | | | Indicator (CRI) |
| | | | | value, i.e the |
| | | | | index of a CSI- |
| | | | | RS resource |
| | | | | within a set of |
| | | | | resources of the |
| | | | | NZP-CSI-RS |
| | | | | configured by |
| | | | | the aggressor. |
| >SSB_based | | | | |
| >> SSB Area CLI List | 0 . . . 1 | | | |
| >>> SSB Area CLI | 1 . . . | | | |
| Item | <maxnoofSSBAreas> | | | |
| >>>>SSB Index | M | | INTEGER(0 | |
| | | | . . . 63) | |
| >>>>CLI Power | M | [0 . . . X] | INTEGER | Number of dBm |
| | | | (0 . . . X) | of CLI power |

TABLE 20

| Range bound | Explanation |
|---|---|
| maxnoofSSBAreas | Maximum no. SSB Areas that can be served by a |
| | gNB node cell. Value is 64. |

### Section B Part 4—NZP-CSI-RS Configuration

This IE contains information describing the NZP-CSI-RS configuration for a cell.

TABLE 21

| | | | IE type and | Semantics |
|---|---|---|---|---|
| IE/Group Name | Presence | Range | reference | description |
| NZP-CSI-RS- | M | | OCTET | Includes the |
| ResourceSet | | | STRING | NZP-CSI-RS- |
| | | | | ResourceSet IE, |
| | | | | as defined in TS |
| | | | | 38.331 [10]. |
| NZP-CSI-RS-Resource | | 1 | | List of CLI |
| List | | | | mitigation |
| | | | | assistance |
| | | | | information per |
| | | | | cell |
| >NZP-CSI-RS-Resource | | 1 . . . | | |
| Item | | <maxnoofNZP- | | |
| | | CSI-RS- | | |
| | | RESOURCE> | | |
| >>NZP-CSI-RS- | M | | OCTET | Includes the |
| Resource | | | STRING | NZP-CSI-RS- |
| | | | | Resource IE, as |
| | | | | defined in TS |
| | | | | 38.331 [10]. |

TABLE 22

| Range bound | Explanation |
|---|---|
| maxnoofNZP-CSI-RS- | Maximum no. of NZP-CSI-RS-Resoures. |
| RESOURCE | Value is 64. |

Note again that techniques herein are well suited to facilitate mitigation of wireless interference in a network environment to support better use of available wireless resources. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A method comprising:
at a first wireless station:
receiving reference signal configuration information indicating a configuration of a second wireless station transmitting reference signals;
monitoring for receipt of the reference signals as indicated by the reference signal configuration information; and
based on receipt of a first reference signal as indicated by the reference signal configuration information, detecting wireless interference at the first wireless station as caused by the second wireless station.

2. The method as in claim 1 further comprising:
in response to detecting the wireless interference, transmitting a first communication from the first wireless station to the second wireless station, the first communication requesting mitigation of the detected wireless interference by the second wireless station.

3. The method as in claim 2, wherein the first communication includes a request for the second wireless station to adjust use of a respective wireless beam from which the first reference signal and data signals are transmitted from the second wireless station.

4. The method as in claim 2, wherein the reference signals as indicated by the reference signal configuration information are unique wireless reference signals transmitted in multiple different directional wireless beams from the second wireless station; and
wherein the first reference signal is wirelessly transmitted in a first wireless beam of the multiple different wireless beams.

5. The method as in claim 4, wherein the first communication transmitted from the first wireless station to the second wireless station indicates that the transmission of the first wireless beam from the second wireless station results in the wireless interference to the first wireless station.

6. The method as in claim 5, wherein the second wireless station is operative to transmit both the first reference signal and a first data signal via the first wireless beam, the first data signal being transmitted from the second wireless station via the first wireless beam to a third wireless station.

7. The method as in claim 1 further comprising:
at the first wireless station, based on attributes of the first reference signal, determining an identity of a first wireless beam from which the second wireless station transmits the first reference signal; and
in response to detecting the wireless interference, transmitting a first communication from the first wireless station to the second wireless station, the first communication indicating the identity of the first wireless beam.

8. The method as in claim 7, wherein the first communication includes a request for the second wireless station to mitigate the wireless interference caused by the second wireless station transmitting the first wireless beam, the method further comprising:
at the first wireless station, in response to transmitting the first communication, receiving a second communication from the second wireless station, the second communication including notification of an attempt by the second wireless station to mitigate the wireless interference.

9. The method as in claim 8, wherein the attempt by the second wireless station to mitigate the wireless interference reduces the wireless interference caused by the second wireless station transmitting the first wireless beam, the method further comprising:
in response to the first wireless station detecting a desired amount of reduction in the wireless interference caused by the second wireless station transmitting the first wireless beam, transmitting a third communication from the first wireless station to the second wireless station, the third communication notifying the second wireless station to terminate further mitigation of the wireless interference caused by the second wireless station transmitting the first wireless beam.

10. The method as in claim 1 further comprising:
transmitting a first communication to the second wireless station in response to detecting that the first reference signal is received at the first wireless station above a first wireless power threshold level; and
wherein the first communication transmitted from the first wireless station to the second wireless station indicates that the transmission of the first reference signal from the second wireless station results in the wireless interference to the first wireless station.

11. The method as in claim 1, wherein the reference signal configuration information received at the first wireless station is second reference signal configuration information received from the second wireless station;
wherein the reference signals as indicated by the second reference signal configuration information are second reference signals, the method further comprising:
transmitting first reference signal configuration information from the first wireless station to the second wireless station, the first reference signal configuration information indicating a configuration of the first wireless station transmitting first reference signals in multiple different wireless beams.

12. The method as in claim 11 further comprising:
at the first wireless station, subsequent to transmitting the first reference signal configuration information, receiving a communication from the second wireless station, the communication indicating that transmission of a second wireless beam from the first wireless base station results in wireless interference to the second wireless station.

13. The method as in claim 1 further comprising:
at the first wireless station, monitoring for receipt of the reference signals as indicated by the reference signal configuration information in response to receiving a command from the second wireless station, the command indicating to implement wireless interference testing at the first wireless station.

14. The method as in claim 1, wherein the reference signal configuration information provides a mapping of identities of the reference signals transmitted by the second wireless station to corresponding wireless beams used by the second wireless station to transmit the reference signals.

15. A system comprising:
communication management hardware associated with a first wireless station, the communication management hardware operative to:
receive reference signal configuration information indicating a configuration of a second wireless station transmitting reference signals;
monitor for receipt of the reference signals as indicated by the reference signal configuration information; and
based on receipt of a first reference signal as indicated by the reference signal configuration information, detect wireless interference at the first wireless station as caused by the second wireless station.

16. The system as in claim 15, wherein the communication management hardware is further operative to:
in response to detecting the wireless interference, transmit a first communication from the first wireless station to the second wireless station, the first communication requesting mitigation of the detected wireless interference by the second wireless station.

17. The system as in claim 16, wherein the first communication includes a request for the second wireless station to adjust use of a respective wireless beam from which the first reference signal and data signals are transmitted from the second wireless station.

18. The system as in claim 16, wherein the reference signals as indicated by the reference signal configuration information are unique wireless reference signals transmitted in multiple different directional wireless beams from the second wireless station; and
wherein the first reference signal is wirelessly transmitted in a first wireless beam of the multiple different wireless beams.

19. The system as in claim 18, wherein the first communication transmitted from the first wireless station to the second wireless station indicates that the transmission of the first wireless beam from the second wireless station results in the wireless interference to the first wireless station.

20. The system as in claim 19, wherein the second wireless station is operative to transmit both the first reference signal and a first data signal via the first wireless beam, the first data signal being transmitted from the second wireless station via the first wireless beam to a third wireless station.

21. The system as in claim 15, wherein the communication management hardware is further operative to:
at the first wireless station, based on attributes of the first reference signal, determine an identity of a first wireless beam from which the second wireless station transmits the first reference signal; and
in response to detecting the wireless interference, transmit a first communication from the first wireless station to the second wireless station, the first communication indicating the identity of the first wireless beam.

22. The system as in claim 21, wherein the first communication includes a request for the second wireless station to mitigate the wireless interference caused by the second wireless station transmitting the first wireless beam, the communication management hardware further operative to:
at the first wireless station, in response to transmitting the first communication, receive a second communication from the second wireless station, the second communication including notification of an attempt by the second wireless station to mitigate the wireless interference.

23. The system as in claim 22, wherein the attempt by the second wireless station to mitigate the wireless interference reduces the wireless interference caused by the second wireless station transmitting the first wireless beam, the communication management hardware further operative to:
in response to the first wireless station detecting a desired amount of reduction in the wireless interference caused by the second wireless station transmitting the first wireless beam, transmit a third communication from the first wireless station to the second wireless station, the third communication notifying the second wireless station to terminate further mitigation of the wireless interference caused by the second wireless station transmitting the first wireless beam.

24. The system as in claim 15, wherein the communication management hardware is further operative to:
transmit a first communication to the second wireless station in response to detecting that the first reference signal is received at the first wireless station above a first wireless power threshold level; and
wherein the first communication transmitted from the first wireless station to the second wireless station indicates that the transmission of the first reference signal from the second wireless station results in the wireless interference to the first wireless station.

25-28. (canceled)

29. Computer-readable storage hardware having instructions stored thereon, the instructions, when carried out by computer processor hardware associated with a first wireless station, cause the computer processor hardware to:
receive reference signal configuration information indicating a configuration of a second wireless station transmitting reference signals;
monitor for receipt of the reference signals as indicated by the reference signal configuration information; and
based on receipt of a first reference signal as indicated by the reference signal configuration information, contact wireless interference at the first wireless station as caused by the second wireless station.
